(19) United States
(12) Patent Application Publication
(10) Pub. No.: US 2025/0327960 A1
(43) Pub. Date: Oct. 23, 2025

(54) OPTICAL ELEMENT AND DISPLAY DEVICE

(71) Applicant: Sharp Display Technology Corporation, Kameyama City (JP)

(72) Inventors: Jianeng XU, Kameyama City (JP); Yuichi KAWAHIRA, Kameyama City (JP); Masahiro HASEGAWA, Kameyama City (JP); Ryosuke SAIGUSA, Kameyama City (JP); Takeshi OYAMA, Kameyama City (JP); Akira SAKAI, Kameyama City (JP)

(21) Appl. No.: 19/182,675

(22) Filed: Apr. 18, 2025

(30) Foreign Application Priority Data
Apr. 22, 2024 (JP) 2024-069075

(51) Int. Cl. G02B 5/30; G02F 1/1335

(52) U.S. Cl. CPC G02B 5/3083; G02F 1/133536; G02F 1/133607

(57) ABSTRACT

An optical element includes a first polarizer, a first retardation layer including first anisotropic molecules, a negative C plate, a second retardation layer including second anisotropic molecules, a second polarizer, a third retardation layer including third anisotropic molecules, a fourth retardation layer including fourth anisotropic molecules, and a third polarizer. Tilt angles of the third anisotropic molecules decrease from the second polarizer side of the third retardation layer toward the fourth retardation layer side of the third retardation layer. Tilt angles of the fourth anisotropic molecules decrease from the third polarizer side of the fourth retardation layer toward the third retardation layer side of the fourth retardation layer. An angle formed by the slow axis of the third retardation layer and the slow axis of the fourth retardation layer is 10° or greater and 20° or smaller.

### CROSS-REFERENCE TO RELATED APPLICATIONS

This application claims the benefit of priority to Japanese Patent Application Number 2024-069075 filed on Apr. 22, 2024. The entire contents of the above-identified application are hereby incorporated by reference.

### BACKGROUND

### Technical Field

The following disclosure relates to an optical element and a display device including the optical element.

Hitherto, various display devices such as liquid crystal display devices and organic electro-luminescence (EL) display devices have been widely used as devices for displaying videos (moving images and still images). In order to improve the visibility of such display devices, optical elements may be used.

For example, PCT International Publication No. WO 2017/110216 discloses a transmissive optical element including, from a visual recognition side, a polarizing plate and at least one inclined-aligned retardation film in this order, (i) an absorption axis of the polarizing plate and a slow axis of the inclined-aligned retardation film being in the ranges of +15 degrees to +55 degrees and −15 degrees to −55 degrees, and (ii) the inclined-aligned retardation film having an in-plane retardation of 110 nm to 240 nm and an average tilt angle γ relative to the film plane of 22 degrees to 55 degrees.

### SUMMARY

The disclosure provides an optical element that makes a light shielding region vertically asymmetric, while curbing light leakage in an oblique direction in the vertical azimuthal direction and can further curb coloring in an oblique direction, and a display device including the optical element.

(1) An embodiment of the disclosure is an optical element including a first polarizer; a first retardation layer including first anisotropic molecules; a negative C plate; a second retardation layer including second anisotropic molecules; a second polarizer; a third retardation layer including third anisotropic molecules; a fourth retardation layer including fourth anisotropic molecules; and a third polarizer in this order, in which the first anisotropic molecules vary in a manner that tilt angles of the first anisotropic molecules increase from the first polarizer side of the first retardation layer toward the negative C plate side of the first retardation layer, the second anisotropic molecules vary in a manner that tilt angles of the second anisotropic molecules increase from the second polarizer side of the second retardation layer toward the negative C plate side of the second retardation layer, the third anisotropic molecules vary in a manner that tilt angles of the third anisotropic molecules decrease from the second polarizer side of the third retardation layer toward the fourth retardation layer side of the third retardation layer, the fourth anisotropic molecules vary in a manner that tilt angles of the fourth anisotropic molecules decrease from the third polarizer side of the fourth retardation layer toward the third retardation layer side of the fourth retardation layer, an absorption axis or a reflection axis of the first polarizer, an absorption axis or a reflection axis of the second polarizer, and an absorption axis or a reflection axis of the third polarizer are parallel to each other in a plan view,
the absorption axis or the reflection axis of the first polarizer and a slow axis of the first retardation layer are orthogonal to each other in a plan view,
the slow axis of the first retardation layer and a slow axis of the second retardation layer are parallel to each other in a plan view, a slow axis of the third retardation layer and a slow axis of the fourth retardation layer intersect each other in a plan view, and an angle formed by the slow axis of the third retardation layer and the slow axis of the fourth retardation layer is 10° or greater and 20° or smaller.

(2) An embodiment of the disclosure is an optical element in which, in addition to the configuration of (1) described above, an angle formed by the slow axis of the second retardation layer and the slow axis of the third retardation layer is 5° or greater and 10° or smaller, and an angle formed by the slow axis of the first retardation layer and the slow axis of the fourth retardation layer is 5° or greater and 10° or smaller.

(3) An embodiment of the disclosure is an optical element in which, in addition to the configuration of (1) or (2) described above, when a surface of the first retardation layer on the first polarizer side is assumed to be a first surface, a surface of the second retardation layer on the second polarizer side is assumed to be a second surface, a surface of the third retardation layer on the second polarizer side is assumed to be a third surface, and a surface of the fourth retardation layer on the third polarizer side is assumed to be a fourth surface, and an azimuthal direction in which directions along long axes of the first anisotropic molecules from a side closer to the second surface of the first retardation layer toward a side closer to the first surface of the first retardation layer are projected onto the first surface is assumed to be an orientation direction of the first anisotropic molecules, an azimuthal direction in which directions along long axes of the second anisotropic molecules from a side closer to the second surface of the second retardation layer toward a side closer to the first surface of the second retardation layer are projected onto the second surface is assumed to be an orientation direction of the second anisotropic molecules, an azimuthal direction in which directions along long axes of the third anisotropic molecules from a side closer to the fourth surface of the third retardation layer toward a side closer to the third surface of the third retardation layer are projected onto the third surface is assumed to be an orientation direction of the third anisotropic molecules, and
an azimuthal direction in which directions along long axes of the fourth anisotropic molecules from a side closer to the fourth surface of the fourth retardation layer toward a side closer to the third surface of the fourth retardation layer are projected onto the fourth surface is assumed to be an orientation direction of the fourth anisotropic molecules, the orientation direction of the first anisotropic molecules and the orientation direction of the second anisotropic molecules are different from each other by 180°±3° in a plan view.

(4) An embodiment of the disclosure is an optical element in which, in addition to the configuration of (3) described above, when a horizontal rightward direction of the optical element viewed from a side of the first polarizer is an azimuth angle of 0°, a counterclockwise direction from the azimuth angle of 0° is a positive angle, and a clockwise direction from the azimuth angle of 0° is a negative angle, the orientation direction of the first anisotropic molecules is 0°±3° and the orientation direction of the second anisotropic molecules is 180°±3°, or the orientation direction of the first anisotropic molecules is 180°±3° and the orientation direction of the second anisotropic molecules is 0°±3°.

(5) An embodiment of the disclosure is an optical element in which, in addition to the configuration of (3) or (4) described above, in a plan view, the orientation direction of the third anisotropic molecules is an azimuthal direction obtained by rotating the orientation direction of the second anisotropic molecules in one of a clockwise direction and a counterclockwise direction by a predetermined angle, and in a plan view, the orientation direction of the fourth anisotropic molecules is an azimuthal direction obtained by rotating the orientation direction of the first anisotropic molecules in the other of the clockwise direction and the counterclockwise direction by the predetermined angle.

(6) An embodiment of the disclosure is an optical element in which, in addition to the configuration of (5) described above, the predetermined angle is 5° or greater and 10° or smaller.

(7) An embodiment of the disclosure is an optical element in which, in addition to the configuration of any one of (1) to (6) described above, a retardation of the negative C plate in a thickness direction is 250 nm or more and 320 nm or less.

(8) An embodiment of the disclosure is an optical element in which, in addition to the configuration of any one of (1) to (7) described above, a rate of variation in the tilt angles of the first anisotropic molecules from the first polarizer side to the negative C plate side in a thickness direction of the first retardation layer is equal to a rate of variation in the tilt angles of the second anisotropic molecules from the second polarizer side to the negative C plate side in a thickness direction of the second retardation layer.

(9) An embodiment of the disclosure is an optical element in which, in addition to the configuration of any one of (1) to (8) described above, a rate of variation in the tilt angles of the third anisotropic molecules from the fourth retardation layer side to the second polarizer side in a thickness direction of the third retardation layer is equal to a rate of variation in the tilt angles of the fourth anisotropic molecules from the third retardation layer side to the third polarizer side in a thickness direction of the fourth retardation layer.

(10) An embodiment of the disclosure is an optical element in which, in addition to the configuration of any one of (1) to (9) described above, the first polarizer is an absorptive polarizer, a reflective polarizer, or a layered body of an absorptive polarizer and a reflective polarizer, the second polarizer is an absorptive polarizer or a reflective polarizer, and the third polarizer is an absorptive polarizer, a reflective polarizer, or a layered body of an absorptive polarizer and a reflective polarizer.

(11) Another embodiment of the disclosure is a display device including a liquid crystal panel, the optical element described in any one of (1) to (10) described above, and a backlight in this order, in which the optical element is disposed in a manner that the first polarizer is on a side of the liquid crystal panel.

(12) An embodiment of the disclosure is a display device in which, in addition to the configuration of (11) described above, the backlight includes an irradiation unit and a prism sheet disposed on an observation surface side of the irradiation unit, the prism sheet is provided with a plurality of rows of linear protruding portions extending parallel to each other on a surface on the observation surface side, and the absorption axis or the reflection axis of the first polarizer is parallel or orthogonal to ridge lines of the linear protruding portions in a plan view.

According to the disclosure, it is possible to provide an optical element that makes a light shielding region vertically asymmetric, while curbing light leakage in an oblique direction in the vertical azimuthal direction and can further curb coloring in an oblique direction, and a display device including the optical element.

### BRIEF DESCRIPTION OF DRAWINGS

The disclosure will be described with reference to the accompanying drawings, wherein like numbers reference like elements.

FIG. 1 is a diagram showing a polar angle and an azimuth angle.

FIG. 2 is a schematic cross-sectional view of an optical element according to a first embodiment.

FIG. 3 illustrates exploded perspective views for describing slow axes of respective retardation layers and orientation directions of anisotropic molecules.

FIG. 4 is a diagram illustrating the axial azimuthal directions of members of the optical element according to the first embodiment.

FIG. 5 is a schematic cross-sectional view of a display device according to a second embodiment.

FIG. 6 is a perspective view showing an example of a prism sheet provided in a backlight.

FIG. 7 is a diagram showing the axial azimuthal directions of respective members of an optical element according to Comparative Example 1.

FIG. 8 shows simulation results of a transmittance viewing angle and coloring of the optical element according to Comparative Example 1.

FIG. 9 shows simulation results of a transmittance viewing angle and coloring of an optical element according to Comparative Example 2.

FIG. 10 shows simulation results of a transmittance viewing angle and coloring of an optical element according to Comparative Example 3.

FIG. 11 shows simulation results of a transmittance viewing angle and coloring of an optical element according to Comparative Example 4.

FIG. 12 shows simulation results of a transmittance viewing angle and coloring of an optical element according to Comparative Example 5.

FIG. 13 shows simulation results of a transmittance viewing angle and coloring of an optical element according to Example 1.

FIG. 14 shows simulation results of a transmittance viewing angle and coloring of an optical element according to Example 2.

FIG. 15 shows simulation results of a transmittance viewing angle and coloring of an optical element according to Comparative Example 6.

FIG. 16 shows simulation results of a transmittance viewing angle and coloring of an optical element according to Comparative Example 7.

FIG. 17 is a graph showing the transmittance of the optical element according to Comparative Example 1.

FIG. 18 is a graph showing the transmittance of the optical element according to Example 1.

FIG. 19 is a graph showing the transmittance of the optical element according to Example 2.

FIG. 20 shows simulation results of a transmittance viewing angle of an optical element according to Comparative Example 8.

FIG. 21 is a graph showing the relationship between the rotation angle of anisotropic molecules in the orientation direction and the relative ratio of the maximum transmittance.

FIG. 22 is a graph showing the relationship between the rotation angle of anisotropic molecules in the orientation direction and the transmittance at a polar angle of 60° at an azimuth angle of 90°.

FIG. 23 is a graph showing the relationship between the rotation angle of anisotropic molecules in the orientation direction and Δxy.

FIG. 24 is a graph showing the relationship between the retardation of a negative C plate in the thickness direction and a transmittance.

FIG. 25 is a graph showing the relationship between the retardation of the negative C plate in the thickness direction and Δxy.

### DESCRIPTION OF EMBODIMENTS

Liquid crystal display devices are broadly classified into reflective and transmissive types depending on a method of light transmission into a liquid crystal layer. A transmissive liquid crystal display device includes a backlight having a light source, and display is performed by a liquid crystal layer transmitting light emitted from the backlight. The backlight may be provided with a prism sheet (lens sheet) on an observation surface side of the light source to condense light, which is emitted from the light source, to the front surface thereof.

In the backlight equipped with the prism sheet, light components with large polar angles of light incident on the prism sheet from the light source are scattered by a prism (uneven structure) of the prism sheet and may be emitted from the prism sheet at a larger polar angle without being condensed to the front surface. Such light components that are not condensed by the lens sheet and leak out at a large polar angle are referred to as “side lobe light”. Side lobe light is a light component that is not necessary for image display and is prone to becoming stray light within a liquid crystal panel, which can cause light leakage of oblique light (light with a large polar angle) in the case of black display, which can be a factor in reducing contrast when viewed from an oblique direction.

According to the present inventors' study, depending on the configuration of the backlight, side lobe light is likely to occur in the vertical azimuthal direction, and thus there was room for further study in order to curb light leakage in an oblique direction in a vertical azimuthal direction. In addition, in a use mode in which a user observes an optical element from above or from below, it may be desirable to make the visibility of the optical element viewed from above and the visibility of the optical element viewed from below asymmetric. For example, when an optical element is used by being overlaid on an in-vehicle display, a user observes the optical element from above, and thus it is desirable that the visibility of the optical element viewed from above be higher than the visibility thereof viewed from below. Furthermore, according to the present inventors' study, when an optical element is viewed in an oblique direction, displayed images may appear in unintended colors, and thus there is room for further study.

In WO 2017/110216, although disposing a specific optical element on an observation surface side of a display device to curb a decrease in visibility due to reflection of external light has been discussed, a decrease in contrast due to side lobe light, asymmetry in visibility from above and from below, and coloring in an oblique direction have never been discussed.

The disclosure has been made in consideration of the above-mentioned current situation.

Embodiments according to the disclosure will be described hereinafter. The technology according to the disclosure is not limited to the contents described in the following embodiments, and appropriate design changes can be made within a scope that satisfies the configuration according to the disclosure. In the description below, the same reference signs are appropriately used in common among the different drawings for the same parts or parts having similar functions, and repeated description thereof will be omitted as appropriate. The aspects of the disclosure may be combined as appropriate within a range that does not depart from the gist of the disclosure.

### Definition of Terms

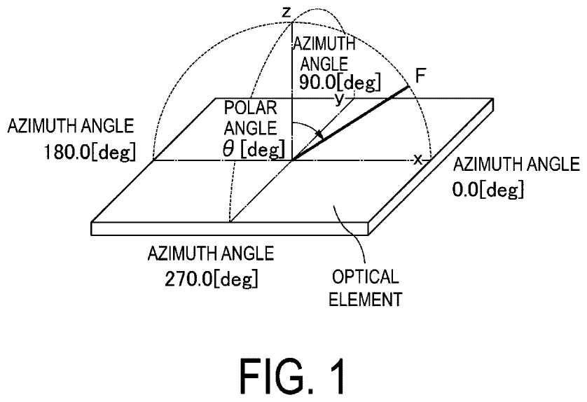

FIG. 1 is a diagram showing a polar angle and an azimuth angle. In this specification, as shown in FIG. 1, a “polar angle θ” means an angle between a target direction (for example, a measurement direction F) and a direction parallel to a normal to a principal surface of an optical element. That is, the direction parallel to the normal (z) to the principal surface (xy plane) of the optical element has a polar angle of 0°. The direction parallel to the normal is also referred to as a normal direction. Additionally, the azimuthal direction refers to a direction when a target direction is projected onto the principal surface of the optical element, and is expressed as an angle (also referred to as an azimuth angle) between the target direction and a reference azimuthal direction (azimuth angle of 0°). The reference azimuthal direction is set, for example, to be a horizontal rightward direction when the optical element is viewed from a viewer's side.

In this specification, the expression “two axes (directions) are parallel” means that an angle (absolute value) formed between the axes is in a range of 0±3°, is preferably in a range of 0±1°, is more preferably in a range of 0±0.5°, and is particularly preferably 0° (completely parallel). In this specification, the expression “two axes (directions) are orthogonal to each other” means that an angle (absolute value) formed between the axes is in a range of 90±3°, is preferably in a range of 90±1°, is more preferably in a range of 90±0.5°, and is particularly preferably 90° (completely orthogonal). The above-mentioned axes include a transmission axis and reflection axis of a polarizer and a slow axis of a retardation layer.

In this specification, a birefringent layer means a layer in which any one of absolute values of a retardation in an in-plane direction (in-plane retardation) Re and a retardation in a thickness direction Rth has a value of 10 nm or more, preferably a value of 20 nm or more. The birefringent layer includes a retardation layer and a negative C plate. The retardation Re in the in-plane direction of the birefringent layer, the retardation Rth in the thickness direction of the birefringent layer, and an NZ coefficient (biaxial parameter) are defined by the following equations, where d is the thickness of the birefringent layer, nx is a refractive index in an x-axis direction, ny is a refractive index in a y-axis direction, and nz is a refractive index in a z-axis direction. ns indicates the larger one of nx and ny, and of indicates the smaller one. Here, the x-axis is set at an azimuth angle of 0° to 180°, the y-axis is set at an azimuth angle of 90° to 270°, and the z-axis is orthogonal to the x-axis and the y-axis. In this specification, Re, Rth and the NZ coefficient are 550 nm and a measurement temperature is 23° C. unless otherwise specified. Unless otherwise specified, the retardation refers to the in-plane retardation Re.

$$Re = ( ns - nf ) \times d$$

$$Rth = \{ nz - ( nx + ny ) / 2 \} \times d$$

$$NZ = ( ns - nz ) / ( ns - nf )$$

“Azimuth angle of A° to B°” refers to a direction along the azimuth angle of A° and the azimuth angle of B° in a plan view. In this specification, the azimuth angle of 0° to 180° is also referred to as a horizontal azimuthal direction, and the azimuth angle of 90° to 270° is also referred to as a vertical azimuthal direction. Further, an azimuth angle of 90° is referred to as an upward direction, and an azimuth angle of 270° is referred to as a downward direction.

In this specification, an observation surface side means the side of a target member which is closer to a viewer when the target member is disposed facing the viewer, and a back surface side means the side of the target member which is farther from the viewer.

### First Embodiment

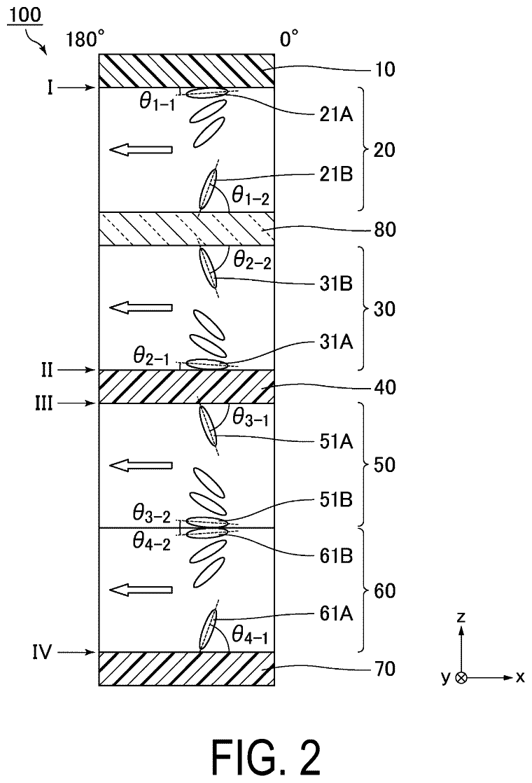

FIG. 2 is a schematic cross-sectional view of an optical element according to a first embodiment. As illustrated in FIG. 2, the optical element 100 according to the first embodiment includes a first polarizer 10, a first retardation layer 20, a negative C plate 80, a second retardation layer 30, a second polarizer 40, a third retardation layer 50, a fourth retardation layer 60, and a third polarizer 70 in this order. Since the optical element 100 functions as an optical louver, a configuration including the members from the first polarizer 10 to the third polarizer 70 is also referred to as a polarizing plate louver. When a configuration including the first polarizer 10, the first retardation layer 20, the negative C plate 80, the second retardation layer 30, and the second polarizer 40 in this order is regarded as one polarizing plate louver, and a configuration including the second polarizer 40, the third retardation layer 50, the fourth retardation layer 60, and the third polarizer 70 in this order is regarded as another polarizing plate louver, the optical element 100 can also be regarded as an optical element in which the two polarizing plate louvers are stacked. In the embodiment, the first polarizer 10 side of the optical element 100 is also referred to as an observation surface side, and the third polarizer 70 side is also referred to as a back surface side. The optical element 100 may be used such that the first polarizer 10 side is the back surface side and the third polarizer 70 side is the observation surface side. From the viewpoint of being able to curb a blue color viewed from an oblique direction, it is preferable that the first polarizer 10 side is the observation surface side.

### Polarizer

The first polarizer 10, the second polarizer 40, and the third polarizer 70 have a function of extracting polarized light (linearly polarized light) that vibrates only in a specific direction from unpolarized light (natural light), partially polarized light, or polarized light, and are also referred to as linear polarizing plates. Each of the first polarizer 10, the second polarizer 40, and the third polarizer 70 may be an absorptive polarizer or a reflective polarizer. The absorptive polarizer has an absorption axis that absorbs light vibrating in a specific direction, and a transmission axis that transmits polarized light (linearly polarized light) vibrating in a direction orthogonal to the specific direction. The reflective polarizer has a reflection axis that reflects light vibrating in a specific direction, and a transmission axis that transmits polarized light (linearly polarized light) vibrating in a direction orthogonal to the specific direction.

All of the first polarizer 10, the second polarizer 40 and the third polarizer 70 may be absorptive polarizers. With such an aspect, when a backlight is disposed on the back surface side of the optical element 100, side lobe light can be absorbed, and the light shielding property in an oblique direction in the vertical azimuthal direction can be further enhanced.

The first polarizer 10 may be an absorptive polarizer, and the third polarizer 70 may be a reflective polarizer. Since the third polarizer 70 on the back surface side is configured as a reflective polarizer, when a backlight is disposed on the back surface side of the optical element 100, light can be recycled by reflecting side lobe light to the backlight side and emitting the reflected light again to the observation surface side by a reflection plate or the like of the backlight, and luminance in the normal direction during white display can be increased.

The first polarizer 10 may be an absorptive polarizer, a reflective polarizer, or a layered body of an absorptive polarizer and a reflective polarizer. The second polarizer 40 may be an absorptive polarizer or a reflective polarizer. The third polarizer 70 may be an absorptive polarizer, a reflective polarizer, or a layered body of an absorptive polarizer and a reflective polarizer. The polarizer disposed on the observation surface side is preferably an absorptive polarizer or a layered body of an absorptive polarizer and a reflective polarizer, and the polarizer disposed on the back surface side is preferably a reflective polarizer or a layered body of an absorptive polarizer and a reflective polarizer. When the first polarizer 10 is a layered body of an absorptive polarizer and a reflective polarizer, the absorptive polarizer and the reflective polarizer are preferably layered in this order from the observation surface side. When the third polarizer 70 is a layered body of an absorptive polarizer and a reflective polarizer, the absorptive polarizer and the reflective polarizer are preferably layered in this order from the observation surface side. Although the reflective polarizer has an effect of improving luminance in the normal direction during white display, the degree of polarization is lower than that of the absorptive polarizer. Thus, when only the reflective polarizer is used, the contrast of the polarizing plate louver may decrease. For this reason, the absorptive polarizer and the reflective polarizer are layered, and thus it is possible to increase the contrast while improving the luminance in the normal direction. When the absorptive polarizer and the reflective polarizer are layered, the transmission axis of the absorptive polarizer and the transmission axis of the reflective polarizer are parallel to each other.

It is more preferable that both the first polarizer 10 and the third polarizer 70 be a layered body of an absorptive polarizer and a reflective polarizer. In each of the first polarizer 10 and the third polarizer 70, it is more preferable that the reflective polarizer be layered on the back surface side of the absorptive polarizer. In a display device in which a liquid crystal panel is disposed on the front surface side of an optical element and a backlight is disposed on the back surface side of the optical element, luminance and contrast can be further increased. When the third polarizer 70 located on the backlight side is configured as a layered body of an absorptive polarizer and a reflective polarizer, light emitted from the backlight can be more efficiently reflected to the backlight side, and light recycling efficiency can be increased. When the first polarizer 10 disposed on the liquid crystal panel side is configured as a layered body of an absorptive polarizer and a reflective polarizer, light incident from the backlight side is further reflected to the backlight side, and the luminance of the front surface of the liquid crystal panel can be improved.

An example of the absorptive polarizer is one including a polarizing layer in which an anisotropic material such as an iodine complex having dichroism is adsorbed and aligned to a polyvinyl alcohol (PVA) film. A protective film such as a triacetyl cellulose (TAC) film may be provided on at least one of the observation surface side and the back surface side of the polarizing layer.

Examples of the reflective polarizer include reflective polarizers (for example, APCF manufactured by Nitto Denko Corporation, DBEF manufactured by 3M Co., Ltd., and the like) obtained by uniaxially stretching a co-extruded film made of a plurality of types of resins, reflective polarizers (so-called wire grid polarizers) in which thin metallic wires are periodically arranged, and the like.

### Retardation Layer

The first retardation layer 20, the second retardation layer 30, the third retardation layer 50, and the fourth retardation layer 60 have a function of changing the state of incident polarized light by providing a retardation between two polarized light components orthogonal to each other using a birefringent material or the like.

As illustrated in FIG. 2, the first retardation layer 20 contains first anisotropic molecules 21, the second retardation layer 30 contains second anisotropic molecules 31, the third retardation layer 50 contains third anisotropic molecules 51, and the fourth retardation layer 60 contains fourth anisotropic molecules 61. The first anisotropic molecules 21 vary such that tilt angles thereof increase from the first polarizer 10 side of the first retardation layer 20 toward the negative C plate 80 side of the first retardation layer 20. The second anisotropic molecules 31 vary such that tilt angles thereof increase from the second polarizer 40 side of the second retardation layer 30 toward the negative C plate 80 side of the second retardation layer 30. The third anisotropic molecules 51 vary such that the tilt angles thereof decrease from the second polarizer 40 side of the third retardation layer 50 toward the fourth retardation layer 60 side of the third retardation layer 50. The fourth anisotropic molecules 61 vary such that the tilt angles thereof decrease from the third polarizer 70 side of the fourth retardation layer 60 toward the third retardation layer 50 side of the fourth retardation layer 60. In this specification, the plan view refers to viewing an object from the observation surface side.

In this specification, among the first anisotropic molecules 21 contained in the first retardation layer 20, a first anisotropic molecule located on the first polarizer 10 side of the first retardation layer 20 is a first anisotropic molecule 21A, a first anisotropic molecule located on the negative C plate 80 side of the first retardation layer 20 is a first anisotropic molecule 21B, the tilt angle of the first anisotropic molecule 21A is θ₁₋₁, and the tilt angle of the first anisotropic molecule 21B is θ₁₋₂. Among the second anisotropic molecules 31 contained in the second retardation layer 30, a second anisotropic molecule located on the second polarizer 40 side of the second retardation layer 30 is a second anisotropic molecule 31A, a second anisotropic molecule located on the negative C plate 80 side of the second retardation layer 30 is a second anisotropic molecule 31B, the tilt angle of the second anisotropic molecule 31A is θ₂₋₁, and the tilt angle of the second anisotropic molecule 31B is θ₂₋₂. Among the third anisotropic molecules 51 contained in the third retardation layer 50, a third anisotropic molecule located on the second polarizer 40 side of the third retardation layer 50 is a third anisotropic molecule 51A, a third anisotropic molecule located on the fourth retardation layer 60 side of the third retardation layer 50 is a third anisotropic molecule 51B, the tilt angle of the third anisotropic molecule 51A is θ₃₋₁, and the tilt angle of the third anisotropic molecule 51B is θ₃₋₂. Among the fourth anisotropic molecules 61 contained in the fourth retardation layer 60, a fourth anisotropic molecule located on the third polarizer 70 side of the fourth retardation layer 60 is a fourth anisotropic molecule 61A, a fourth anisotropic molecule located on the third retardation layer 50 side of the fourth retardation layer 60 is a fourth anisotropic molecule 61B, the tilt angle of the fourth anisotropic molecule 61A is θ₄₋₁, and the tilt angle of the fourth anisotropic molecule 61B is θ₄₋₂.

Unless otherwise specified, the tilt angle of the first anisotropic molecule 21 is an angle at which the long axis of the first anisotropic molecule 21 is tilted with respect to a surface parallel to the surface (first surface I) of the first retardation layer 20 on the first polarizer 10 side. The tilt angle of the second anisotropic molecule 31 is an angle at which the long axis of the second anisotropic molecule 31 is tilted with respect to a surface parallel to the surface (second surface II) of the second retardation layer 30 on the second polarizer 40 side. The tilt angle of the third anisotropic molecule 51 is an angle at which the long axis of the third anisotropic molecule 51 is tilted with respect to a surface parallel to the surface (third surface III) of the third retardation layer 50 on the second polarizer 40 side. The tilt angle of the fourth anisotropic molecule 61 is an angle at which the long axis of the fourth anisotropic molecule 61 is tilted with respect to a surface parallel to the surface (fourth surface IV) of the fourth retardation layer 60 on the third polarizer 70 side. The tilt angle is defined as 0° or more and 90° or less.

It is preferable that the first anisotropic molecules 21, the second anisotropic molecules 31, the third anisotropic molecules 51, and the fourth anisotropic molecules 61 be aligned so that the tilt angles thereof continuously vary in the thickness directions of the first retardation layer 20, the second retardation layer 30, the third retardation layer 50, and the fourth retardation layer 60, respectively. The phrase “the tilt angles continuously vary” means that the tilt angles of anisotropic molecules are aligned to gradually increase or decrease from one surface side to the other surface side of each retardation layer.

As illustrated in FIG. 2, θ₁₋₁ is smaller than θ₁₋₂, and θ₂₋₁ is smaller than θ₂₋₂. The θ₃₋₁ is greater than θ₃₋₂, and θ₄₋₁ is greater than θ₄₋₂. It can be said that the first anisotropic molecules 21, the second anisotropic molecules 31, the third anisotropic molecules 51, and the fourth anisotropic molecules 61 are hybrid-aligned to have different tilt angles in the thickness directions of the first retardation layer 20, the second retardation layer 30, the third retardation layer 50, and the fourth retardation layer 60, respectively. When the anisotropic molecules in each of the retardation layers are hybrid-aligned and have an axial arrangement to be described below, the optical element 100 can have a color tone close to a single color when viewed from an oblique direction.

The first retardation layer 20 and the negative C plate 80 may be in contact with each other, the negative C plate 80 and the second retardation layer 30 may be in contact with each other, and the third retardation layer 50 and the fourth retardation layer 60 may be in contact with each other.

It is preferable that variations in tilt angles of the first anisotropic molecules 21 and the second anisotropic molecules 31 be symmetrical in a cross-sectional view. It is preferable that the rate of variation in the tilt angles of the first anisotropic molecules 21 from the first polarizer 10 side to the negative C plate 80 side in the thickness direction of the first retardation layer 20 be equal to the rate of variation in the tilt angles of the second anisotropic molecules 31 from the second polarizer 40 side to the negative C plate 80 side in the thickness direction of the second retardation layer 30. The rate of variation in the tilt angles of the first anisotropic molecules can be expressed by the following Equation (1), and the rate of variation in the tilt angles of the second anisotropic molecules can be expressed by the following Equation (2).

$$Rate of variation in tilt angles of first anisotropic molecules = {θ}_{1 - 2} - {θ}_{1 - 1} / thickness ( μ m ) of first retardation layer \qquad ( 1 )$$

$$Rate of variation in tilt angles of second anisotropic molecules = {θ}_{2 - 2} - {θ}_{2 - 1} / thickness ( μ m ) of second retardation layer \qquad ( 2 )$$

It is preferable that variations in the tilt angles of the third anisotropic molecules 51 and the fourth anisotropic molecules 61 be symmetrical in a cross-sectional view. It is preferable that the rate of variation in the tilt angles of the third anisotropic molecules 51 from the fourth retardation layer 60 side to the second polarizer 40 side in the thickness direction of the third retardation layer 50 be equal to the rate of variation in the tilt angles of the fourth anisotropic molecules 61 from the third retardation layer 50 side to the third polarizer 70 side in the thickness direction of the fourth retardation layer 60. The rate of variation in the tilt angles of the third anisotropic molecules can be expressed by the following Equation (3), and the rate of variation in the tilt angles of the fourth anisotropic molecules can be expressed by the following Equation (4).

$$Rate of variation in tilt angles of third anisotropic molecules = {θ}_{3 - 1} - {θ}_{3 - 2} / thickness ( μ m ) of third retardation layer \qquad ( 3 )$$

$$Rate of variation in tilt angles of fourth anisotropic molecules = {θ}_{4 - 1} - {θ}_{4 - 2} / thickness ( μ m ) of fourth retardation layer \qquad ( 4 )$$

It is preferable that a difference between the thickness of the first retardation layer and the thickness of the second retardation layer be 1 μm or less, and it is more preferable that the thicknesses of both the retardation layers be the same. It is preferable that a difference between the thickness of the third retardation layer and the thickness of the fourth retardation layer be 1 μm or less, and it is more preferable that the thicknesses of both the retardation layers be the same.

It is preferable that a direction in which the tilt angles of the first anisotropic molecules 21 of the first retardation layer 20 vary be the same as a direction in which the tilt angles of the second anisotropic molecules 31 of the second retardation layer 30 vary. In addition, it is preferable that a direction in which the tilt angles of the third anisotropic molecules 51 of the third retardation layer 50 vary be the same as a direction in which the tilt angles of the fourth anisotropic molecules 61 of the fourth retardation layer 60 vary.

A direction in which tilt angles of anisotropic molecules vary refers to a direction in which directions along the optical axes of the anisotropic molecules from a side closer to one surface of a retardation layer to a side closer to the other surface are projected onto the one surface. Here, the tilt angle of the anisotropic molecule on the one surface side is smaller than the tilt angle of the anisotropic molecule on the other surface side. That is, it can be said that the one surface is a surface on the side where the tilt angle of the anisotropic molecule is small, and the other surface is a surface on the side where the tilt angle of the anisotropic molecule is large. In the cross-sectional views (FIG. 2 and the like), the directions in which the tilt angles of the anisotropic molecules vary are indicated by the orientation of white arrows. The above-described one surface refers to the surface of the first retardation layer 20 on the first polarizer 10 side (first surface I), the surface of the second retardation layer 30 on the negative C plate 80 side (second surface II), the surface of the third retardation layer 50 on the fourth retardation layer 60 side, or the surface of the fourth retardation layer 60 on the third retardation layer 50 side.

From the viewpoint of being able to further reduce a transmittance in an oblique direction in a vertical azimuthal direction, the θ₁₋₂ and the θ₂₋₂ are preferably 65° or more and 90° or less. From the viewpoint of being able to further curb coloring in an oblique direction, the θ₁₋₂ and the θ₂₋₂ are more preferably 70° or more and 80° or less.

The θ₁₋₁ and the θ₂₋₁ may be smaller than the θ₁₋₂ and the θ₂₋₂, and are preferably, for example, 0° or more and 10° or less, more preferably 1° or more and 5° or less.

A difference between the θ₁₋₁ and the θ₂₋₁ is preferably 3° or less and more preferably 1° or less, and it is further preferable that the θ₁₋₁ and the θ₂₋₁ be the same. A difference between the θ₁₋₂ and the θ₂₋₂ is preferably 3° or less and more preferably 1° or less, and it is further preferable that the θ₁₋₂ and the θ₂₋₂ be the same.

From the viewpoint of being able to further reduce a transmittance in an oblique direction in a vertical azimuthal direction, the θ₃₋₁ and the θ₄₋₁ are preferably 65° or more and 90° or less. From the viewpoint of further curbing coloring in an oblique direction, the θ₃₋₁ and the θ₄₋₁ are more preferably 70° or more and 80° or less.

The θ₃₋₂ and the θ₄₋₂ may be smaller than the θ₃₋₁ and the θ₄₋₁, and are preferably, for example, 0° or more and 10° or less and more preferably 1° or more and 5° or less.

A difference between the θ₃₋₁ and the θ₄₋₁ is preferably 3° or less and more preferably 1° or less, and it is further preferable that the θ₃₋₁ and the θ₄₋₁ be the same. A difference between the θ₃₋₂ and the θ₄₋₂ is preferably 3° or less and more preferably 1° or less, and it is further preferable that the θ₃₋₂ and the θ₄₋₂ be the same.

The orientation direction of anisotropic molecules will be described below. As illustrated in FIG. 2, the surface of the first retardation layer 20 on the first polarizer 10 side is assumed to be a first surface I, the surface of the second retardation layer 30 on the second polarizer 40 side is assumed to be a second surface II, the surface of the third retardation layer 50 on the second polarizer 40 side is assumed to be a third surface III, and the surface of the fourth retardation layer 60 on the third polarizer 70 side is assumed to be a fourth surface IV. The orientation direction of the first anisotropic molecules refers to an azimuthal direction in which directions along the long axes of the first anisotropic molecules from a side closer to the second surface II of the first retardation layer to a side closer to the first surface I are projected onto the first surface I. The orientation direction of the second anisotropic molecules refers to an azimuthal direction in which directions along the long axes of the second anisotropic molecule from a side closer to the second surface II of the second retardation layer to a side closer to the first surface I are projected onto the second surface II. The orientation direction of the third anisotropic molecules refers to an azimuthal direction in which directions along the optical axes of the third anisotropic molecule from a side closer to the fourth surface IV of the third retardation layer to a side closer to the third surface III are projected onto the third surface III. The orientation direction of the fourth anisotropic molecules refers to an azimuthal direction in which directions along the optical axes of the fourth anisotropic molecules from a side closer to the fourth surface IV of the fourth retardation layer to a side closer to the third surface III are projected onto the fourth surface IV. That is, the orientation direction of the anisotropic molecules in the embodiment refers to an azimuthal direction in which directions along the optical axes of the anisotropic molecules from the back surface side to the observation surface side are projected onto the surface of the retardation layer. Unless otherwise specified, the orientation direction of the anisotropic molecules refers to an average orientation direction of the anisotropic molecules contained in each retardation layer.

It is preferable that the orientation direction of the first anisotropic molecules 21 and the orientation direction of the second anisotropic molecules 31 be different from each other by 180°±3° in a plan view. Since the orientation direction of the first anisotropic molecules 21 and the orientation direction of the second anisotropic molecules 31 are substantially parallel and opposite to each other, coloring, from an oblique direction, of one polarizing plate louver including the first polarizer 10, the first retardation layer 20, the negative C plate 80, the second retardation layer 30, and the second polarizer 40 in this order can be a single color.

When a horizontal rightward direction of the optical element viewed from the first polarizer 10 side is set to an azimuth angle of 0°, a counterclockwise direction from the azimuth angle of 0° is set to be a positive angle, and a clockwise direction is set to be a negative angle, it is more preferable that the orientation direction of the first anisotropic molecules 21 be 0°±3° and the orientation direction of the second anisotropic molecules 31 be 180°±3°, or the orientation direction of the first anisotropic molecules 21 be 180°±3° and the orientation direction of the second anisotropic molecules 31 be 0°±3°.

In a plan view, the third anisotropic molecules 51 are preferably aligned in an azimuthal direction obtained by rotating the orientation direction of the second anisotropic molecules 31 in one of the clockwise and counterclockwise directions by a predetermined angle n₁, and in a plan view, the fourth anisotropic molecules 61 are preferably aligned in an azimuthal direction obtained by rotating the orientation direction of the first anisotropic molecules 21 in the other of the clockwise and counterclockwise directions by a predetermined angle n₂. With such a configuration, the light shielding region can be vertically asymmetric, that is, the center of the light shielding region can be slightly shifted upward or downward with respect to the azimuthal direction 90° to 270°.

In a plan view, it is more preferable that the third anisotropic molecules 51 be aligned in an azimuthal direction obtained by rotating the orientation direction of the second anisotropic molecules 31 clockwise by a predetermined angle n₁, and the fourth anisotropic molecules 61 are aligned in an azimuthal direction obtained by rotating the orientation direction of the first anisotropic molecules 21 counterclockwise by a predetermined angle n₂. With this configuration, the center of the light shielding region is slightly shifted upward with respect to the azimuthal direction 90° to 270°, and the transmittance of the optical element in the upward direction can be made higher than the transmittance thereof in the downward direction. When the optical element is used by being overlaid on an in-vehicle display, it is preferable that the center of the light shielding region is slightly shifted upward from the viewpoint of visibility improvement. On the other hand, in a plan view, the third anisotropic molecules 51 may be aligned in an azimuthal direction obtained by rotating the orientation direction of the second anisotropic molecules 31 counterclockwise by a predetermined angle n₁, and the fourth anisotropic molecules 61 may be aligned in an azimuthal direction obtained by rotating the orientation direction of the first anisotropic molecules 21 clockwise by a predetermined angle n₂. In that mode, the center of the light shielding region is slightly shifted downward with respect to the azimuthal direction 90° to 270°, and the transmittance of the optical element in the downward direction can be made higher than the transmittance thereof in the upward direction.

Each of the predetermined angle n₁ and the predetermined angle n₂ is preferably 5° or greater and 10° or smaller. By setting both the predetermined angle n₁ and the predetermined angle n₂ to 5° or greater and 10° or smaller, the center of the light shielding region can be shifted slightly upward or downward with respect to the azimuthal direction 90° to 270° without substantially affecting the front luminance and the louver performance. The difference between the predetermined angle n₁ and the predetermined angle n₂ is preferably 3° or smaller, and more preferably the same. By setting the absolute value of the rotation angle n₁ equal to the absolute value of the rotation angle n₂, the center of the light shielding region can be slightly shifted upward or downward while maintaining the bilateral symmetry of the light shielding region.

From the viewpoint of preventing reflection on the windshield when the optical element is used in an in-vehicle display or the like, the absolute value of the rotation angle n₁ and the absolute value of the rotation angle n₂ are preferably 7° or smaller. From the viewpoint of further curbing coloring in an oblique direction (e.g., a polar angle of 60° at an azimuth angle of 90°), the absolute value of the rotation angle n₁ and the absolute value of the rotation angle n₂ are preferably 6° or smaller.

It is preferable that the first anisotropic molecules 21 be not twisted in the thickness direction of the first retardation layer 20, it is preferable that the second anisotropic molecules 31 be not twisted in the thickness direction of the second retardation layer 30, it is preferable that the third anisotropic molecules 51 be not twisted in the thickness direction of the third retardation layer 50, and it is preferable that the fourth anisotropic molecules 61 be not twisted in the thickness direction of the fourth retardation layer 60.

The in-plane retardations of the first retardation layer 20, the second retardation layer 30, the third retardation layer 50, and the fourth retardation layer 60 are preferably 180 nm or more and 250 nm or less. By adopting such an aspect, it is possible to more effectively curb oblique light in the vertical azimuthal direction. The in-plane retardations of the first to fourth retardation layers are more preferably 190 nm or more and 240 nm or less, and further preferably 200 nm or more and 230 nm or less.

Here, examples of the first anisotropic molecule 21, the second anisotropic molecule 31, the third anisotropic molecule 51, and the fourth anisotropic molecule 61 include molecules having a positive wavelength dispersion characteristic in which a birefringence index (retardation) decreases as the wavelength becomes longer. When anisotropic molecules having positive wavelength dispersion characteristics are used, the transmittance of the optical element 100 in an oblique direction varies at each wavelength, and thus the optical element is visually recognized as being colored in multiple mixed colors. As a method of correcting such coloring from an oblique direction, it is conceivable to further dispose a retardation layer containing anisotropic molecules having a reverse wavelength dispersion characteristic in which a birefringence index increases as the wavelength becomes longer. However, anisotropic molecules having an ideal wavelength dispersion characteristic capable of correcting coloring have not been realized. In the present embodiment, the retardation layers, which appear as a single color when viewed from oblique directions but have different color tones, are layered, and thus it is possible to cancel the color tones when the entire optical element 100 is viewed from an oblique direction and correct the color tone when the display device is viewed from oblique directions. When a configuration including the first polarizer 10, the first retardation layer 20, the second retardation layer 30, and the second polarizer 40 is regarded as one polarizing plate louver, and a configuration including the second polarizer 40, the third retardation layer 50, the fourth retardation layer 60, and the third polarizer 70 is regarded as another polarizing plate louver, the optical element 100 can also be regarded as an optical element in which two polarizing plate louvers are overlaid. For example, when any one of the one polarizing plate louver and the other polarizing plate louver appears in blue in an oblique direction, the other polarizing plate louvers appears in yellow in the oblique direction, the color tone of the entire optical element 100 when viewed from an oblique direction can be corrected.

The first anisotropic molecules 21, the second anisotropic molecules 31, the third anisotropic molecules 51, and the fourth anisotropic molecules 61 are molecules that cause the first retardation layer 20, the second retardation layer 30, the third retardation layer 50, and the fourth retardation layer 60 to exhibit birefringence, respectively. The anisotropic molecules are molecules that exhibit anisotropy of a refractive index of light when the molecules are aligned in a specific direction. Examples of the anisotropic molecules include liquid crystalline materials such as a polymerizable liquid crystal and a cured product of a polymerizable liquid crystal. The polymerizable liquid crystal will be described in detail later.

The first retardation layer 20, the second retardation layer 30, the third retardation layer 50, and the fourth retardation layer 60 may be, for example, a reactive mesogen layer (coating retardation layer) formed of a cured product of a polymerizable liquid crystal (reactive mesogen). The coating retardation layer can be formed, for example, by applying a polymerizable liquid crystal onto an alignment film subjected to alignment process and curing the liquid crystal by a method such as baking or light irradiation. The cured polymerizable liquid crystal is aligned in accordance with the orientation direction of an alignment film determined by the alignment process and exhibits retardation. The tilt angles of the first anisotropic molecules 21, the second anisotropic molecules 31, the third anisotropic molecules 51, and the fourth anisotropic molecules 61 can be controlled and hybrid-aligned by adjusting the type of polymerizable liquid crystal, baking conditions, light irradiation conditions (the wavelength, the intensity, and the irradiation angle of irradiation light), and the like.

As the alignment film used as a base of the coating retardation layer, those generally used in the field of liquid crystal panels such as polyimide can be used. Rubbing, light irradiation, or the like can be used for the alignment process of the alignment film.

### Negative C Plate

The optical element 100 includes the negative C plate 80 between the first retardation layer 20 and the second retardation layer 30. By disposing the negative C plate 80 between the first retardation layer 20 and the second retardation layer 30, a variation in the alignment of tilt angles between the first retardation layer 20 and the second retardation layer 30 becomes more continuous. As a result, it is possible to further reduce a transmittance in an oblique direction while maintaining a high transmittance in the normal direction.

The retardation of the negative C plate 80 in the thickness direction is preferably 250 nm or more and 320 nm or less. When the retardation in the thickness direction is set to 250 nm or more and 320 nm or less, it is possible to achieve both a reduction in transmittance in an oblique direction (for example, at the polar angle 60° in the azimuth angle of 90°) in the vertical azimuthal direction and prevention of change in color tones. When the retardation in the thickness direction is set to 250 nm or more, a transmittance in an oblique direction in the vertical azimuthal direction can be set to, for example, 2% or less, and when the retardation in the thickness direction is set to 320 nm or less, a chromaticity shift Δxy can be set to, for example, 0.2 or less. In this specification, the negative C plate refers to a plate satisfying nx=ny>nz and NZ=∞.

A chromaticity shift Δxy is expressed by the following equation. In the following equation, x₀ and y₀ are an x value and a y value of an xy chromaticity diagram in a normal direction of the optical element, respectively, and x and y are an x value and a y value of the xy chromaticity diagram at an arbitrary measurement point of the optical element, respectively.

$$Δ xy = \sqrt{{( {x}_{0} - x )}^{2} + {( {y}_{0} - y )}^{2}} \qquad [ Math . 1 ]$$

### Axial Arrangement of Respective Members

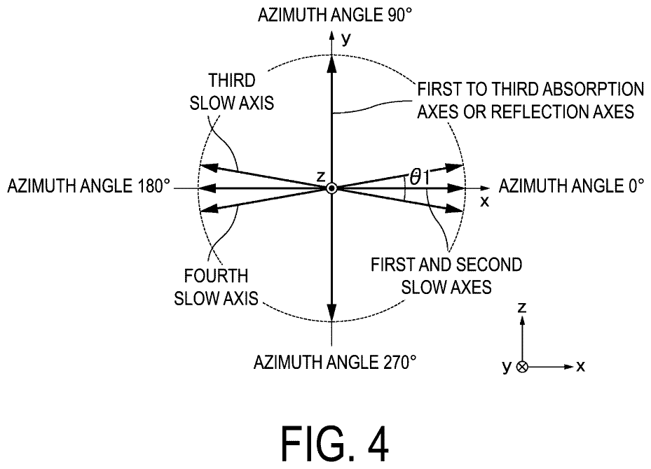

FIG. 4 is a diagram illustrating the axial azimuthal directions of members of the optical element according to the first embodiment. As illustrated in FIG. 4, an absorption axis or a reflection axis of the second polarizer 40 (hereinafter also referred to as a second absorption axis or a second reflection axis) is parallel to an absorption axis of the first polarizer 10 (hereinafter also referred to as a first absorption axis) in a plan view. In addition, an absorption axis or a reflection axis of the third polarizer 70 (hereinafter also referred to as a third absorption axis or a third reflection axis) is parallel to the absorption axis of the first polarizer 10 in a plan view. Since an absorption axis and a transmission axis of an absorptive polarizer are orthogonal to each other, and a reflection axis and a transmission axis of a reflective polarizer are orthogonal to each other in a plan view, it can be said that a transmission axis of the first polarizer 10, a transmission axis of the second polarizer 40, and a transmission axis of the third polarizer 70 are parallel to each other. A slow axis of the first retardation layer 20 (hereinafter also referred to as a first slow axis) is parallel to a slow axis of the second retardation layer 30 (hereinafter also referred to as a second slow axis) and is orthogonal to the first absorption axis or the first reflection axis in a plan view. With such a configuration, it is possible to curb light leakage in an oblique direction in the vertical azimuthal direction and curb coloring in an oblique direction.

As illustrated in FIG. 4, the slow axis of the third retardation layer 50 (hereinafter also referred to as a third slow axis) intersects with the slow axis of the fourth retardation layer 60 (hereinafter also referred to as a fourth slow axis). By making the slow axis of the third retardation layer 50 and the slow axis of the fourth retardation layer 60 included in the lower louver intersect with each other, it is possible to make the light shielding region vertically asymmetric while obtaining a high transmittance in the horizontal azimuthal direction. Even if the slow axis of the first retardation layer 20 and the slow axis of the second retardation layer 30 included in the upper louver located on the observation surface side are made to intersect with each other, sufficient transmittance cannot be obtained. In addition, when the retardation layers included in the upper louver and the lower louver are rotated one by one, the transmission region is shifted from the center of the viewing angle, and thus the transmittance in the normal direction decreases, the transmission region becomes narrower, or coloring deteriorates.

The angle formed by the slow axis of the third retardation layer 50 and the slow axis of the fourth retardation layer 60 is 10° or greater and 20° or smaller. By setting the angle formed by the third slow axis and the fourth slow axis to 10° or greater and 20° or smaller, the light shielding region can be made vertically asymmetric while obtaining high transmittance in the horizontal azimuthal direction. If the angle formed as described above is smaller than 10°, the light shielding region cannot be vertically asymmetric. When the angle formed as described above exceeds 20°, while the light shielding region can be vertically asymmetric, the transmittance at the center of the viewing angle is significantly reduced. Furthermore, coloring in an oblique direction occurs. The angle formed as described above can be adjusted to a desired angle by, for example, forming the third retardation layer 50 and the fourth retardation layer 60, respectively, rotating the third retardation layer 50 and the fourth retardation layer 60, and layering the layers by adjusting the directions of the third slow axis and the fourth slow axis.

From the viewpoint of preventing reflection on a windshield when the optical element is used in an in-vehicle display or the like, the angle formed by the third slow axis and the fourth slow axis is preferably 14° or smaller. From the viewpoint of further preventing coloring in an oblique direction (e.g., at the polar angle 60° at an azimuth angle of 90°), the angle formed by the third slow axis and the fourth slow axis is preferably equal to or less than 12°.

The third slow axis and the fourth slow axis are preferably not parallel to the first slow axis or the second slow axis, and preferably intersect with the first slow axis or the second slow axis. The angle formed by the slow axis of the second retardation layer 30 and the slow axis of the third retardation layer 50 is preferably 5° or greater and 10° or smaller. The angle formed by the slow axis of the first retardation layer 20 and the slow axis of the fourth retardation layer 60 is preferably 5° or greater and 10° or smaller. With this mode, the light shielding region can be vertically asymmetric while maintaining the bilateral symmetry of the light shielding region and without substantially affecting the front luminance and the coloring in oblique directions. When the third slow axis or the fourth slow axis is parallel to the first slow axis or the second slow axis, the symmetry in the horizontal azimuthal direction may not be maintained.

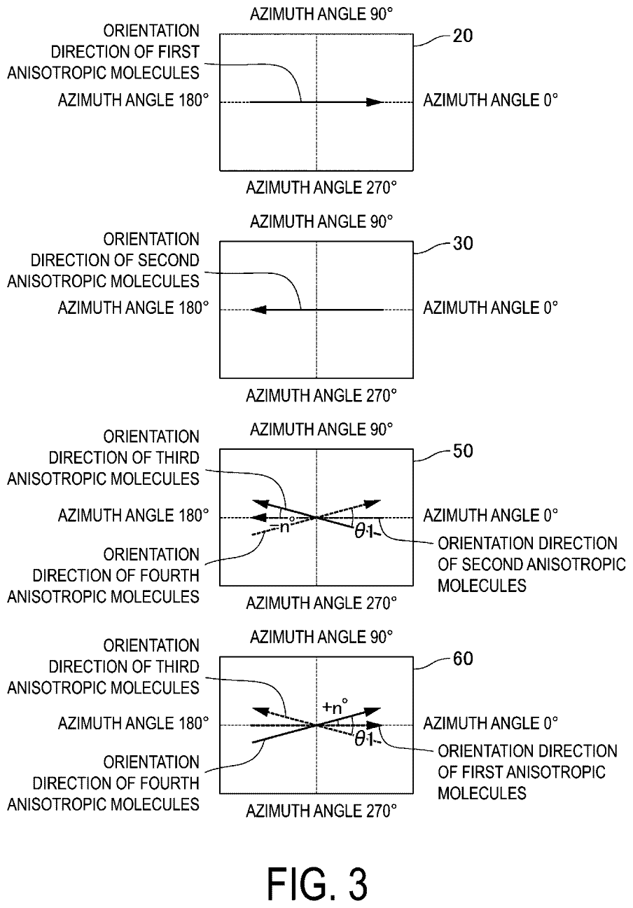

FIG. 3 illustrates exploded plan views for describing slow axes of the retardation layers and orientation directions of anisotropic molecules. As illustrated in FIG. 3, the azimuthal direction of the slow axis of each of the retardation layers refers to an azimuthal direction along the long axes of the anisotropic molecules contained in the retardation layer in a plan view, and the tilt angles of the anisotropic molecules are not considered. The slow axes of the retardation layers are parallel to the orientation directions of the anisotropic molecules, and the orientation directions of the anisotropic molecules are not considered. For example, when both the orientation direction of the first anisotropic molecules 21 and the orientation direction of the second anisotropic molecules 31 are the azimuth angle of 180°, when both the orientation direction of the first anisotropic molecules 21 and the orientation direction of the second anisotropic molecules 31 are the azimuth angle of 0°, and when one of the orientation directions of the first anisotropic molecules 21 and the orientation direction of the second anisotropic molecules 31 is the azimuth angle of 180°, and the other is the azimuth angle of 0°, the slow axis of the first retardation layer 20 is parallel to the slow axis of the second retardation layer 30.

The angle formed by the slow axis of the third retardation layer 50 and the slow axis of the fourth retardation layer 60 refers to the smaller angle of the angles formed by both slow axes, and the orientation directions of the anisotropic molecules are not taken into consideration. For example, when one of the orientation directions of the third anisotropic molecules 51 and the orientation direction of the fourth anisotropic molecules 61 is the azimuth angle of 10° and the other is the azimuth angle of 170°, when one is the azimuth angle of 10° and the other is the azimuth angle of 350°, when one is the azimuth angle of 190° and the other is the azimuth angle of 170°, and when one is the azimuth angle of 190° and the other is the azimuth angle of 350°, the angle formed by the slow axis of the third retardation layer 50 and the slow axis of the fourth retardation layer 60 is 20° in all cases.

The slow axis can be measured using a retardation measuring device (for example, “Axoscan” manufactured by Axometrics, Inc). The Axoscan can measure a retardation, a slow axis, and a tilt angle of an anisotropic molecule. Specifically, characteristics such as a retardation, a slow axis, and a tilt angle of an anisotropic molecule can be measured by measuring and analyzing a matrix (Mueller matrix) including 16 (4×4) elements representing a polarization state of light.

When the first polarizer 10 is an absorptive polarizer, the absorption axis of the first polarizer 10 and the slow axis of the first retardation layer 20 are orthogonal to each other. When the first polarizer 10 is a layered body of an absorptive polarizer and a reflective polarizer, the absorption axis and the reflection axis of the first polarizer 10 are orthogonal to the slow axis of the first retardation layer 20. It can also be said that the transmission axis of the first polarizer 10 and the slow axis of the first retardation layer 20 are parallel to each other.

When the second polarizer 40 is an absorptive polarizer, the second absorption axis and the first absorption axis are parallel to each other, and when the second polarizer 40 is a reflective polarizer, the second reflection axis and the first absorption axis are parallel to each other. When the third polarizer 70 is a reflective polarizer, the third reflection axis and the first absorption axis are parallel to each other, and when the third polarizer 70 is a layered body of a reflective polarizer and an absorptive polarizer, the third reflection axis and the third absorption axis are parallel to the first absorption axis.

### Polymerizable Liquid Crystal

As the polymerizable liquid crystal, a liquid crystal polymer having a photoreactive group is preferably used. Examples of the liquid crystal polymer having a photoreactive group may include a polymer having a side chain structure that combines a mesogenic group such as a biphenyl group, a terphenyl group, a naphthalene group, a phenylbenzoate group, an azobenzene group, or a derivative thereof, which is often used as a mesogen component of a liquid crystal polymer, with a photoreactive group such as a cinnamoyl group, a chalcone group, a cinnamylidene group, a β-(2-phenyl)acryloyl group, a cinnamic acid group, or a derivative thereof, and having a main chain structure such as acrylate, methacrylate, maleimide, N-phenylmaleimide, or siloxane.

The liquid crystal polymer may be a homopolymer configured with a single repeating unit or a copolymer configured with two or more repeating units having different side chain structures. The copolymer includes any of an alternating type, a random type, a graft type, and the like. Further, in the copolymer, the side chain related to at least one repeating unit is a side chain structure having both the mesogenic group and a photoreactive group, but the side chain related to the other repeating unit may not have the mesogenic group or the photoreactive group.

Preferred specific examples of the liquid crystal polymer include a copolymerizable (meth) acrylic acid polymer having a repeating unit represented by the following General Formula (I).

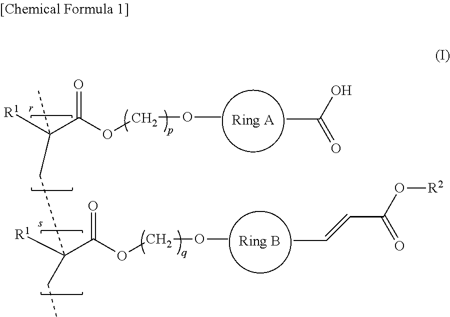

In the above formula, R¹ is a hydrogen atom or a methyl group, R² is an alkyl group or a phenyl group substituted with a group selected from an alkyl group, an alkoxy group, a cyano group and a halogen atom, a ring A and a ring B are each independently a group represented by the following General Formulas (M1) to (M5), p and q are each independently an integer of 1 to 12, and r and s are mole fractions of respective monomers in copolymers satisfying relationships of 0.65≤r≤0.95, 0.05≤s≤0.35 and r+s=1.

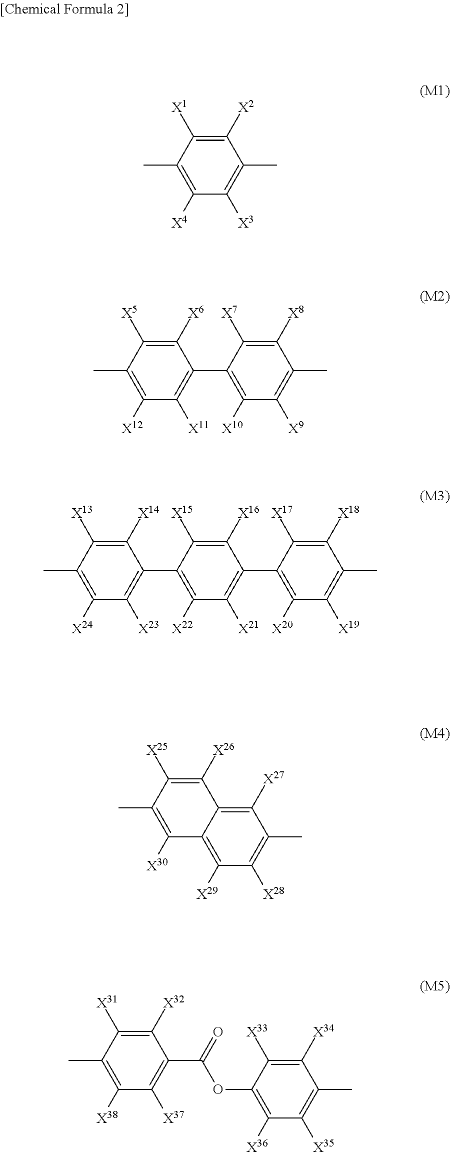

In the above formula, each of X¹ to X³⁸ is independently a hydrogen atom, an alkyl group, an alkoxy group, a halogen atom or a cyano group.

The liquid crystal polymer is preferably a copolymerizable (meth) acrylic acid polymer having a repeating unit represented by the following General Formula (I-a).

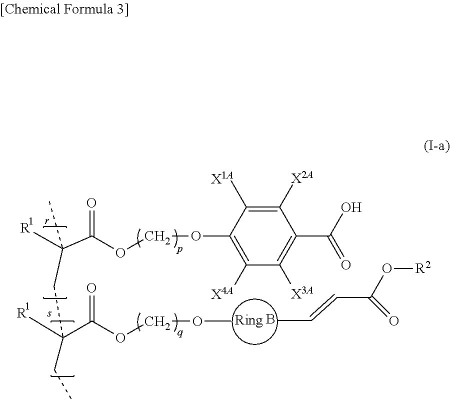

In the above formula, R¹ is a hydrogen atom or a methyl group, R² is an alkyl group or a phenyl group substituted with a group selected from an alkyl group, an alkoxy group, a cyano group and a halogen atom, each of X^{1A} to X^{4A} is independently a hydrogen atom, an alkyl group, an alkoxy group, a halogen atom or a cyano group, a ring B is a group represented by the following General Formula (M1a) or (M5a), p and q are each independently any integer of 1 to 12, and r and s are mole fractions of respective monomers in copolymers satisfying relationships of 0.65≤r≤0.95, 0.05≤s≤0.35, and r+s=1.

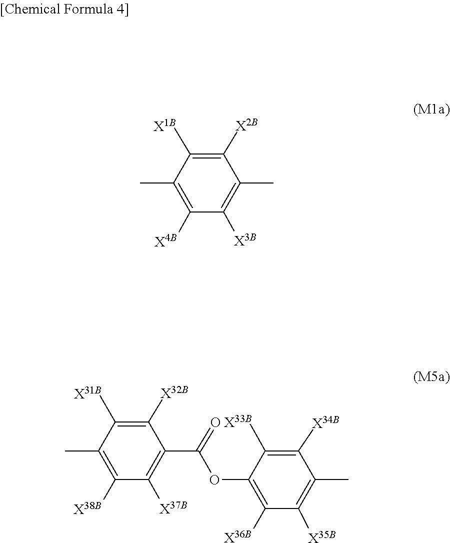

In the above formula, each of X^{1B} to X^{4B} and X^{31B} to X^{38B} is independently a hydrogen atom, an alkyl group, an alkoxy group, a halogen atom or a cyano group.

Further, the liquid crystal polymer is more preferably a copolymerizable (meth) acrylic acid polymer having a repeating unit represented by the following General Formula (I-b) or (I-c).

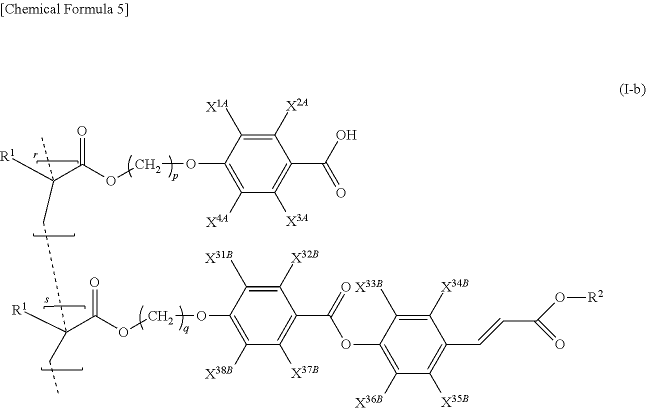

In the above formula, R¹ is a hydrogen atom or a methyl group, R² is an alkyl group or a phenyl group substituted with a group selected from an alkyl group, an alkoxy group, a cyano group and a halogen atom, X^{1A} to X^{4A} and X^{31B} to X^{38B} are each independently a hydrogen atom, an alkyl group, an alkoxy group, a halogen atom or a cyano group, p and q are each independently any integer of 1 to 12, and r and s are mole fractions of respective monomers in copolymers satisfying relationships 0.65≤r≤0.95, 0.05≤s≤0.35 and r+s=1.

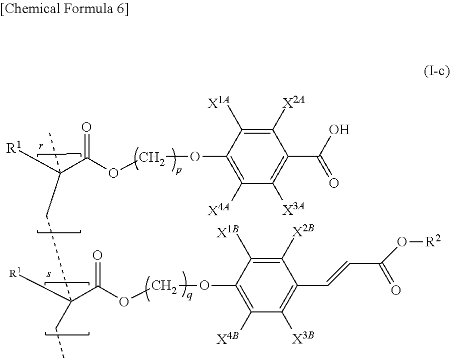

In the above formula, R¹ is a hydrogen atom or a methyl group, R² is an alkyl group or a phenyl group substituted with a group selected from an alkyl group, an alkoxy group, a cyano group and a halogen atom, X^{1A} to X^{4A} and X^{1B} to X^{4B} are each independently a hydrogen atom, an alkyl group, an alkoxy group, a halogen atom or a cyano group, p and q are each independently any integer of 1 to 12, and r and s are mole fractions of respective monomers in copolymers satisfying relationships 0.65≤r≤0.95, 0.05≤s≤0.35 and r+s=1.

In the above General Formula (I) (including General Formula (I-a), General Formula (I-b), and General Formula (I-c), the same applies below), R¹ is preferably a methyl group. R² is preferably an alkyl group or a phenyl group substituted with one group selected from an alkyl group, an alkoxy group, a cyano group and a halogen atom, more preferably an alkyl group or a phenyl group substituted with an alkoxy group or a cyano group, and particularly preferably an alkyl group or a phenyl group substituted with an alkoxy group.

All of X^{31B} and X^{38B} are preferably hydrogen atoms or halogen atoms, and most preferably hydrogen atoms.

Each of p and q is preferably any integer of 3 to 9, more preferably any integer of 5 to 7, and most preferably 6. r is preferably in the range of 0.75≤r≤0.85, and most preferably 0.8. The corresponding preferable range of s is a range naturally determined from r+s=1. That is, it is preferably in the range of 0.15≤s≤0.25, and most preferably 0.2.

In the above General Formula (I-a), (I-b) or (I-c), X^{1A} and X^{4A} are preferably hydrogen atoms or halogen atoms, and it is particularly preferable that any one of X^{1A} to X^{4A} be a halogen atom and the others be hydrogen atoms or all of them be hydrogen atoms. Further, in General Formula (I-b), X^{31B} and X^{38B} are preferably hydrogen atoms or halogen atoms, and it is most preferable that all of them be hydrogen atoms. Further, in General Formula (I-c), X^{1B} and X^{4B} are preferably hydrogen atoms or halogen atoms, and it is most preferable that all of them be hydrogen atoms.

Examples of the alkyl group of R² or the alkyl group as the substituent of the phenyl group of R² include alkyl groups having 1 to 12 carbon atoms, preferably alkyl groups having 1 to 6 carbon atoms, more preferably alkyl groups having 1 to 4 carbon atoms, and most preferably a methyl group. Examples of the alkoxy group as the substituent of the phenyl group of R² include alkoxy groups having 1 to 12 carbon atoms, preferably alkoxy groups having 1 to 6 carbon atoms, more preferably alkoxy groups having 1 to 4 carbon atoms, and most preferably a methoxy group. Examples of the halogen atom as the substituent of the phenyl group of R² include a fluorine atom, a chlorine atom, a bromine atom and an iodine atom, and among these, a fluorine atom is preferable.

In X¹ to X³⁸, examples of the alkyl group include alkyl groups having 1 to 4 carbon atoms, and a methyl group is most preferable. Examples of the alkoxy group include alkoxy groups having 1 to 4 carbon atoms, and a methoxy group is most preferable. Examples of the halogen atom include a fluorine atom, a chlorine atom, a bromine atom, and an iodine atom, and among these, a fluorine atom is preferable.

In this specification, X^{1A} to X^{38A} represent a case where X¹ to X³⁸ which are substituents on the ring A or the ring B are substituents on the ring A, and X^{1B} to X^{38B} represent a case where they are substituents on the ring B. Thus, the description of X¹ to X³⁸ is also applicable to X^{1A} to X^{38A} and X^{1B} to X^{38B} without change.

The liquid crystal polymer can be dissolved in a solvent to prepare a composition for a retardation layer. Further, in addition to a photopolymerization initiator, a surfactant, and the like, components usually contained in a polymerizable composition that causes polymerization by light or heat may be appropriately added to the composition for a retardation layer.

Examples of the solvent used in the composition for a retardation layer include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxybutyl acetate, N-methylpyrrolidone, dimethylacetamide, and the like.

As the photopolymerization initiator, any general-purpose photopolymerization initiator generally known for forming a uniform film by irradiation with a small amount of light can be used. Specific examples of the photopolymerization initiator include azonitrile-based photopolymerization initiators such as 2,2′-azobisisobutyronitrile and 2,2′-azobis(2,4-dimethylvaleronitrile); α-aminoketone-based photopolymerization initiators such as Irgacure 907 (manufactured by Ciba Specialty Chemicals) and Irgacure 369 (manufactured by Ciba Specialty Chemicals); acetophenone-based photopolymerization initiators such as 4-phenoxydichloroacetophenone and 4-t-butyl-dichloroacetophenone; benzoin-based photopolymerization initiators such as benzoin and benzoin methyl ether; benzophenone-based photopolymerization initiators such as benzophenone and benzoylbenzoic acid; thioxanthone-based photopolymerization initiators such as 2-chlorothioxanthone and 2-methylthioxanthone; triazine-based photopolymerization initiators such as 2,4,6-trichloro-s-triazine and 2-phenyl-4,6-bis (trichloromethyl)-s-triazine; carbazole-based photopolymerization initiators; and imidazole-based photopolymerization initiators. The photopolymerization initiator may be used alone or in combination of two or more kinds thereof.

As the surfactant, any of surfactants generally used to form a uniform film can be used. Specific examples of the surfactant include anionic surfactants such as sodium lauryl sulfate and ammonium lauryl sulfate; nonionic surfactants such as polyethylene glycol monolaurate and sorbitan stearate; cationic surfactants such as stearyltrimethylammonium chloride and behenyltrimethylammonium chloride; amphoteric surfactants such as alkylbetaines such as laurylbetaine and alkylsulfobetaine, alkylimidazolines and sodium lauroyl sarcosinate; and surfactants such as BYK-361, BYK-306 and BYK-307 (manufactured by BYK Japan KK), Fluorard FC430 (manufactured by Sumitomo 3M Ltd.), Megafac F171 and R08 (manufactured by Dainippon Ink & Chemicals, Inc.). These surfactants may be used alone or in combination of two or more kinds.

When a liquid crystal polymer having a photoreactive group is used as the polymerizable liquid crystal, the liquid crystal polymer can be aligned by irradiation with polarized light or the like, and thus a coating retardation layer can be formed without providing an alignment film for a base. When the coating retardation layer is formed using a liquid crystal polymer having a photoreactive group, an alignment film can be omitted, and thinning and simplification of the manufacturing process can be achieved.

### Second Embodiment

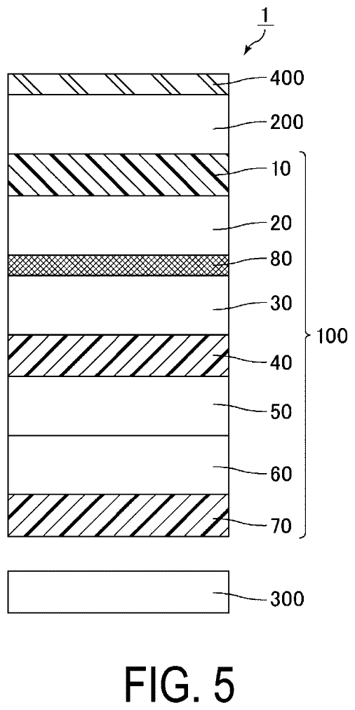

FIG. 5 is a schematic cross-sectional view of a display device according to a second embodiment. As illustrated in FIG. 5, the display device 1 according to the second embodiment includes a liquid crystal panel 200, an optical element 100, and a backlight 300 in this order, and the optical element 100 is disposed such that a first polarizer 10 is on the liquid crystal panel 200 side.

An observation surface side polarizer 400 may be further provided on an observation surface side of the liquid crystal panel 200. As the observation surface side polarizer 400, the above-described absorptive polarizer or reflective polarizer can be used, but the absorptive polarizer is preferable.

An absorption axis of the observation surface side polarizer 400 and an absorption axis or a reflection axis of the first polarizer 10 may be disposed to be orthogonal to each other or may be disposed to be parallel to each other. However, from the viewpoint of obtaining high contrast, it is preferable that the absorption axis of the observation surface side polarizer 400 and the absorption axis or the reflection axis of the first polarizer 10 be disposed to be orthogonal to each other.

Usually, in the liquid crystal panel, a polarizer is disposed on each of the observation surface side and the back surface side, but it is preferable that the first polarizer 10 also serve as a polarizer disposed on the back surface side of the liquid crystal panel. That is, it is preferable that another polarizer be not provided between the liquid crystal panel and the first polarizer 10. The first polarizer 10 may be attached to the back surface side of the liquid crystal panel 200 with an adhesive layer or the like, for example.

### Liquid Crystal Panel

The liquid crystal panel 200 may include a pair of substrates and a liquid crystal layer sandwiched between the pair of substrates. The pair of substrates may be a TFT substrate including a plurality of switching elements such as thin film transistors (TFTs) and a counter substrate. A color filter may be provided on the TFT substrate or may be provided on the counter substrate.

The counter substrate may include, for example, the color filter and a black matrix that partitions the color filter. Examples of the TFT substrate include a configuration in which a gate wiring line and a source wiring line intersecting with the gate wiring line are provided, a TFT is disposed in the vicinity of an intersection of the gate wiring line and the source wiring line, and a pixel electrode electrically connected to the TFT is disposed.

Examples of the liquid crystal panel include liquid crystal panels in a vertical alignment (VA) mode, a fringe field switching (FFS) mode, an in-plane-switching (IPS) mode, a twisted nematic (TN) mode, and the like.

In the VA mode, the counter electrode may be disposed on a CF substrate side, and liquid crystal molecules in the liquid crystal layer may be aligned substantially orthogonal to the substrate surface when no voltage is applied to the liquid crystal layer. In the FFS and IPS modes, the counter electrode may be disposed on the TFT substrate side, and liquid crystal molecules in the liquid crystal layer may be aligned substantially parallel to the substrate surface when no voltage is applied. In the TN mode, the counter electrode may be disposed on the CF substrate side, and liquid crystal molecules in the liquid crystal layer may be spirally aligned to be twisted from the TFT substrate toward the CF substrate by rubbing treatment or the like. The alignment of liquid crystal molecules changes in accordance with an electric field generated in the liquid crystal layer by a voltage applied between the pixel electrode and the counter electrode, and thus the amount of light transmission is controlled. A liquid crystal panel in a horizontal alignment mode such as an FFS mode or an IPS mode is suitably used because it has a wide viewing angle in an oblique direction.

An alignment film may be provided between each of the pair of substrates and the liquid crystal layer. The alignment film is a layer on which alignment process for controlling the alignment of liquid crystal molecules has been performed. Examples of the material of the alignment film include polymers having a main chain such as polyimide, polyamic acid, and polysiloxane, and a photo-alignment film material having a photo-reactive site (functional group) in the main chain or side chain is suitably used.

The liquid crystal molecules may have a positive or negative value of dielectric constant anisotropy (Δε) as defined by the following Equation (L). From the viewpoint of increasing the contrast, the liquid crystal molecules preferably have a negative value of Δε.

Δε=(Dielectric constant in long axis direction)−(Dielectric constant in short axis direction) (L)

### Backlight

The backlight 300 is not particularly limited as long as it can irradiate the liquid crystal panel 200 with light, and may be of any type such as a direct type or an edge type. The backlight 300 may further include a light guide plate, a reflector, or the like.

The backlight 300 may include an irradiation unit and a prism sheet disposed on the observation surface side of the irradiation unit. The irradiation unit is a member that irradiates the liquid crystal panel 200 with light, and examples thereof include a cold cathode fluorescent lamp (CCFL), a light emitting diode (LED), a light guide plate, and the like.

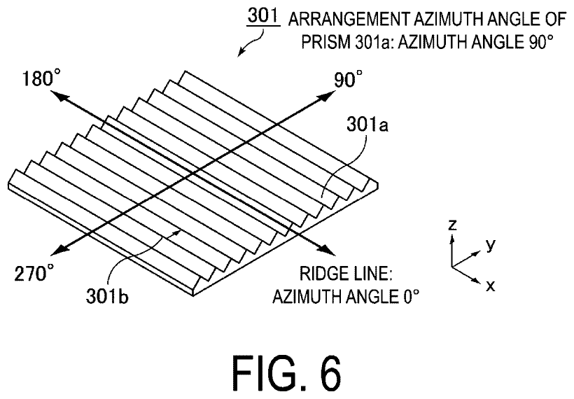

FIG. 6 is a perspective view showing an example of a prism sheet included in a backlight. As shown in FIG. 6, a prism sheet 301 may include a plurality of rows of prisms 301a extending parallel to each other on the surface on the observation surface side. A linearly continuous apex of a protruding portion of the prism 301a is also referred to as a ridge line 301b of the prism sheet.

The ridge line 301b of the prism sheet 301 is preferably disposed parallel to an azimuth angle of 0°. More specifically, the azimuth angle of the ridge line 301b is preferably 0°±3°. By disposing the ridge line 301b in parallel with the azimuth angle of 0°, light condensing on the prism sheet in the horizontal azimuthal direction (azimuth angle of 0° to 180°) is curbed more than that in the vertical azimuthal direction (azimuth angle of 90° to 270°), and it is possible to increase an oblique luminance in the horizontal azimuthal direction and to implement a wide viewing angle. At this time, the arrangement azimuthal direction of the prism 301a orthogonal to the ridge line 301b is an azimuth angle of 90°. Such an aspect is particularly suitably used for the OEM standard which requires a wide luminance viewing angle in the horizontal azimuthal direction.

In a plan view, an absorption axis or a reflection axis of a first polarizer 10, an absorption axis or a reflection axis of a second polarizer 40, and an absorption axis or a reflection axis of a third polarizer 70 are preferably parallel or orthogonal to the ridge line 301b of the prism sheet 301. By adopting such an aspect, it is possible to more effectively reduce oblique light in the vertical azimuthal direction.

Here, the azimuthal direction in which side lobe light is generated varies depending on, for example, the arrangement of the ridge line of the prism sheet included in the backlight. According to the studies of the present inventors, it has been found that, when a backlight including the prism sheet 301 in which the ridge line 301b is disposed parallel to the azimuth angle of 0° (azimuth angle of 0° to 180°) or in parallel with the azimuth angle of 90° (azimuth angle of 90° to 270°) is used, side lobe light is likely to be generated in an oblique direction in a vertical azimuthal direction (azimuth angle of 90° to 270°). For this reason, by combining the optical element 100 with the backlight including the prism sheet 301 in which the ridge line 301b is disposed parallel to the azimuth angle of 0° (azimuth angle of 0° to 180°) or parallel to the azimuth angle of 90° (azimuth angle of 90° to 270°), it is possible to match the azimuth and polar angle at which the side lobe light is generated to the azimuth and polar angle at which a transmittance can be reduced by the optical element 100, thereby effectively curbing the side lobe light.

The backlight may include a reflector on the back surface side of the irradiation unit. As the reflector, a metal deposition film or the like that is commonly used in the field of display devices can be used.

### Example

The disclosure is described in further detail below using examples and comparative examples, but the disclosure is not limited to only these examples.

For the following optical elements according to the examples and comparative examples, a transmittance viewing angle and a chromaticity transmittance viewing angle (colored) were simulated using an LCD Master, and are shown in contour diagrams. Circular dotted lines in the contour diagrams showing transmittance viewing angles and the chromaticity transmittance viewing angles represent polar angles of 20°, 40°, 60°, and 80° from the inside. The shading in the contour diagrams illustrating the transmittance viewing angles corresponds to a transmittance shown on the right side in each diagram. In the contour diagrams of the chromaticity transmittance viewing angles, a dark portion indicates coloring being observed.

### Comparative Example 1

An optical element according to Comparative Example 1 is configured to include a first polarizer, a first retardation layer, a negative C plate, a second retardation layer, a second polarizer, a third retardation layer, a fourth retardation layer, and a third polarizer in this order from the observation surface side, as in Example 1 to be described below (see FIG. 2). Single-layer absorptive linear polarizers were used as the first polarizer, the second polarizer, and the third polarizer. The negative C plate used has Rth=300 nm.

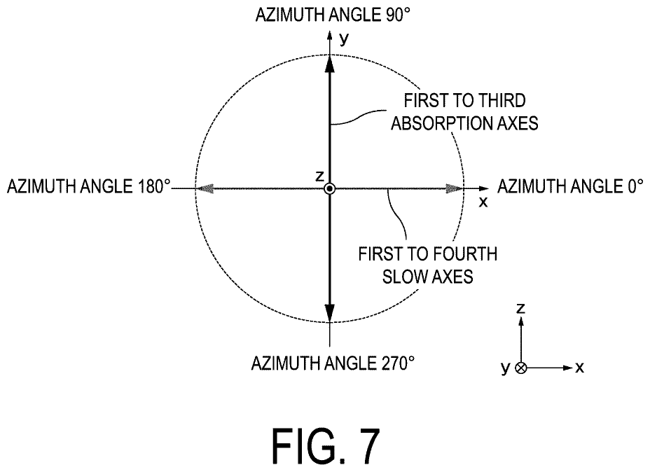

In Comparative Example 1, the absorption axis (first absorption axis) of the first polarizer, the absorption axis (second absorption axis) of the second polarizer, and the absorption axis (third absorption axis) of the third polarizer were disposed to be parallel to the azimuth angle of 90° to 270° such that the absorption axes were parallel to each other in a plan view. FIG. 7 is a diagram illustrating the axial azimuthal directions of respective members of an optical element according to Comparative Example 1. The slow axis (first slow axis) of the first retardation layer, the slow axis (second slow axis) of the second retardation layer, the slow axis (third slow axis) of the third retardation layer, and the slow axis (fourth slow axis) of the fourth retardation layer were disposed to be parallel to the azimuth angle of 0° to 180° such that the axes are parallel to each other. The axial arrangement of each retardation layer shown in Table 1 below represents the orientation direction of the anisotropic molecules contained in the retardation layer.

The tilt angles of the anisotropic molecules contained in the retardation layers are shown in Table 1 below. In Comparative Example 1, similarly to Example 1 to be described below (see FIG. 2), the tilt angles of the first anisotropic molecules were hybrid-aligned to continuously increase from the first polarizer 10 side of the first retardation layer 20 toward the negative C plate 80 side, the tilt angles of the second anisotropic molecules were hybrid-aligned so as to continuously increase from the second polarizer 40 side of the second retardation layer 30 toward the negative C plate 80 side, the tilt angles of the third anisotropic molecules were hybrid-aligned so as to continuously decrease from the second polarizer 40 side of the third retardation layer 50 toward the fourth retardation layer 60 side, and the tilt angles of the fourth anisotropic molecules were hybrid-aligned so as to continuously decrease from the third polarizer 70 side toward the third retardation layer 50 side. The thicknesses of the first retardation layer 20, the second retardation layer 30, the third retardation layer 50, and the fourth retardation layer 60 were set to be equal. In addition, in-plane retardation of each of the first retardation layer 20, the second retardation layer 30, the third retardation layer 50, and the fourth retardation layer 60 was set to 213 nm.

In addition, similarly to Example 1 (see FIG. 2) to be described below, the first anisotropic molecules 21 and the second anisotropic molecules 31 were made to have a symmetrical variation in tilt angles in a cross-sectional view, and the third anisotropic molecules 51 and the fourth anisotropic molecules 61 were made to have a symmetrical variation in tilt angles in a cross-sectional view. Furthermore, the rates of variation in the tilt angles of the first and second anisotropic molecules were set to be equal, and the rates of variation in the tilt angles of the third and fourth anisotropic molecules were set to be equal. The variation directions of the tilt angles of the first anisotropic molecules 21, the second anisotropic molecules 31, the third anisotropic molecules 51, and the fourth anisotropic molecules 61 were set to be the same.

In Table 1 described below, the axial arrangement of the retardation layer indicates the orientation direction (azimuth angle) of anisotropic molecules when the horizontal rightward direction in which the optical element is observed from the first polarizer side is set to an azimuth angle of 0°. A configuration of the first polarizer, the first retardation layer, the negative C plate, and the second retardation layer is also referred to as an upper louver, and a configuration of the second retardation layer, the second polarizer, the third retardation layer, the fourth retardation layer, and the third polarizer is also referred to as a lower louver.

TABLE 1

| | Comparative Example 1 | | |
|---|---|---|---|
| | | Tilt angles of | |
| | Axial | anisotropic | |
| | arrangement | molecules | |
| First polarizer | 90° | | |
| First retardation layer | 0° | θ1-1 | 4° |
| (orientation direction of first anisotropic | | θ1-2 | 70° |
| molecules) | | | |
| Negative C plate | Yes | | |
| Second retardation layer | 180° | θ2-2 | 70° |
| (orientation direction of second | | θ2-1 | 4° |
| anisotropic molecules) | | | |
| Second polarizer | 90° | | |
| Third retardation layer | 180° | θ3-1 | 70° |
| (orientation direction of third anisotropic | | θ3-2 | 4 |
| molecules) | | | |
| Fourth retardation layer | 0° | θ4-2 | 4° |
| (orientation direction of fourth | | θ4-1 | 70° |
| anisotropic molecules) | | | |
| Third polarizer | 90° | | |

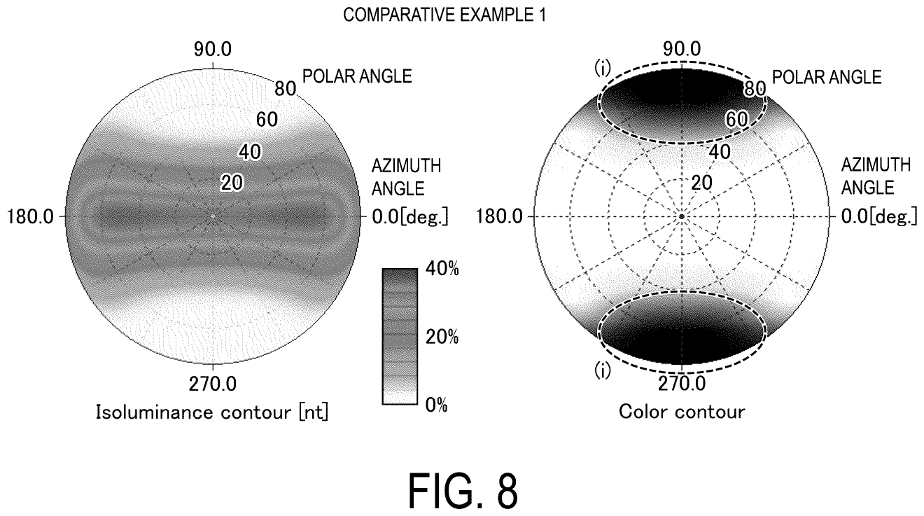

FIG. 8 shows simulation results of a transmittance viewing angle and coloring of the optical element according to Comparative Example 1. From the results of the transmittance viewing angle in FIG. 8, in Comparative Example 1, the light shielding region was symmetrical (bilaterally symmetrical) with respect to the azimuth angle of 90° to 270°, and while the light leakage in the oblique direction in the vertical azimuthal direction was curbed, the light-shielding region was symmetrical (vertically symmetrical) with respect to the azimuth angle of 0° to 180° in the vertical direction. The colors are almost similar in oblique directions of the azimuth angles 90° and 270° indicated by (i) in the contour diagram showing coloring of FIG. 8, and coloring by oblique light was curbed.

The present inventors conceived of the idea that the symmetry of the tilt angle alignment of the anisotropic molecules would be broken and the light shielding region become asymmetric when the molecules were observed in the vertical azimuthal direction by rotating the orientation direction of the anisotropic molecules contained in each retardation layer, and have studied as follows in order to make the light shielding region of the polarizing plate louver vertically asymmetric.

### Comparative Examples 2 and 3

Comparative Example 2 has the same configuration as that of Comparative Example 1 except that the orientation directions of the anisotropic molecules of the first and second retardation layers included in the upper louver of Comparative Example 1 were rotated in the same direction (so that the rotation angles are both positive). Comparative Example 3 has the same configuration as that of Comparative Example 1 except that the orientation directions of the anisotropic molecules of the first and second retardation layers included in the upper louver were rotated in the opposite directions (so that the rotation angles are positive and negative, respectively). Orientation directions of the first to fourth anisotropic molecules are show in Table 2 below. Note that the tilt angles of the anisotropic molecules in the retardation layers and the axial azimuthal directions of the first to third polarizers in the following Examples and Comparative Examples are the same as those in Comparative Example 1 and are as shown in Table 1 above, and thus description thereof is omitted (see Table 1).

TABLE 2

| | Comparative | Comparative | Comparative |
|---|---|---|---|
| | Example 1 | Example 2 | Example 3 |
| Orientation direction of first | 0° | 10° | 10° |
| anisotropic molecules | | | |
| Orientation direction of | 180° | 190° | 170° |
| second anisotropic molecules | | | |
| Orientation direction of | 180° | 180° | 180° |
| third anisotropic | | | |
| molecules | | | |
| Orientation direction of fourth | 0° | 0° | 0° |
| anisotropic molecules | | | |
| Angle formed by the first | 0° | 0° | 20° |
| slow axis and the second | | | |
| slow axis | | | |
| Angle formed by the third | 0° | 0° | 0° |
| slow axis and the fourth | | | |
| slow axis | | | |

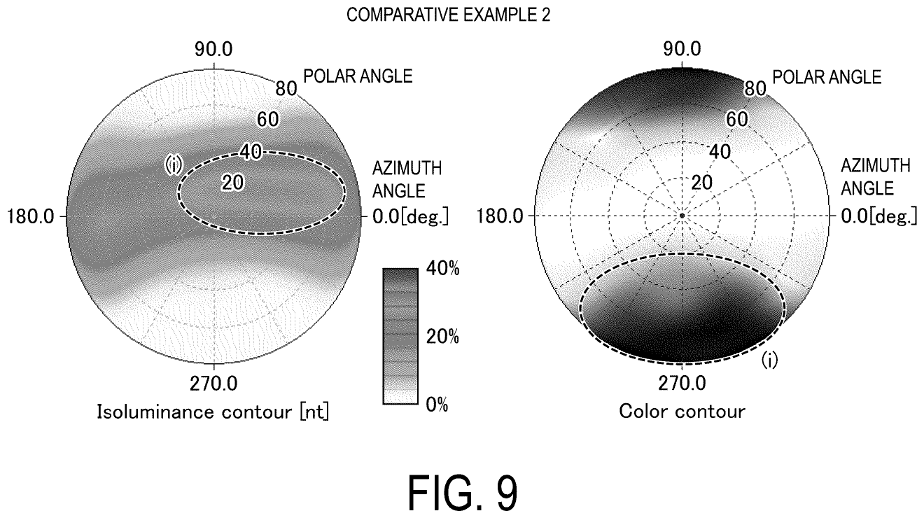

FIG. 9 shows simulation results of a transmittance viewing angle and coloring of an optical element according to Comparative Example 2. From the results of the transmittance viewing angle shown in FIG. 9, in Comparative Example 2, the light shielding region was asymmetric in both the horizontal azimuthal direction and the vertical azimuthal direction. In addition, compared with Comparative Example 1, the maximum luminance region is narrower in the region indicated by (i) in the contour diagram showing the transmittance viewing angle and is shifted from the center of the viewing angle, and therefore, it is presumable that this is not suitable for the polarizing plate louver. From the results of Comparative Example 2, in contrast to Comparative Example 1, by rotating the first and second retardation layers included in the upper louver in the same direction, it was not possible to make the light shielding region vertically asymmetric while maintaining the performance of the polarizing plate louver of curbing light leakage in the vertical direction, making the light shielding region horizontally symmetric, and increasing the transmittance at the center of the viewing angle.

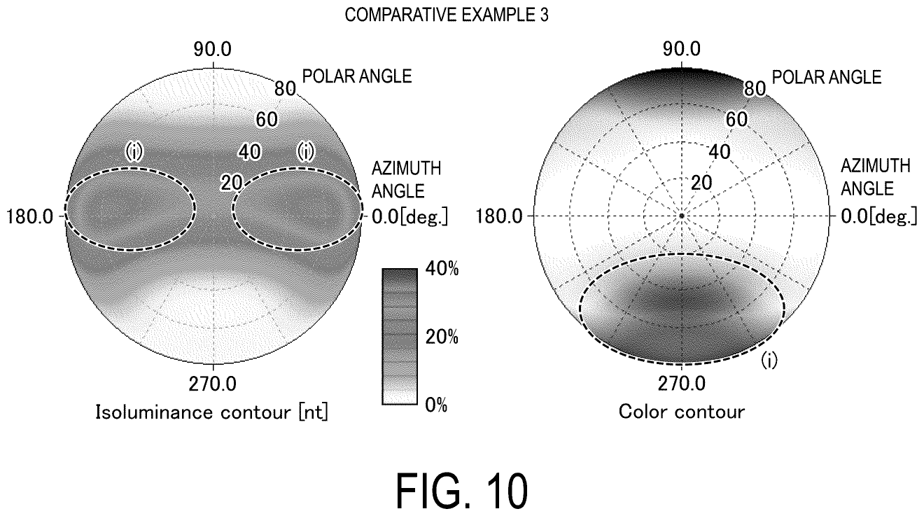

FIG. 10 shows simulation results of a transmittance viewing angle and coloring of an optical element according to Comparative Example 3. From the results of the transmittance viewing angle in FIG. 10, it is presumable that Comparative Example 3 is not suitable for the polarizing plate louver because, while the light shielding region is bilaterally symmetric and vertically asymmetric, the maximum luminance region is narrower and deviated from the center of the viewing angle compared with in Comparative Example 1 as indicated by (i) in the contour diagram showing the transmittance viewing angle. From the results of Comparative Example 3, by rotating the first and second retardation layers included in the upper louver in opposite directions, it was not possible to make the light shielding region vertically asymmetric while maintaining the performance as the polarizing plate louver. On the other hand, since the light shielding region became more vertically asymmetric as compared with Comparative Example 2, it was found that the light shielding region could be made vertically asymmetric by rotating two adjacent retardation layers in opposite directions.

In Comparative Examples 2 and 3, three colors of yellow, purple, and green appeared as the polar angle changes from 20° to 80° at around the azimuth angle of 270° indicated by (i) in the contour diagrams of FIGS. 9 to 11 showing coloring, and the coloring was intense.

### Comparative Examples 4 and 5

In Comparative Examples 4 and 5, any one of the retardation layers included in the upper louver and the lower louver was rotated to further examine the preferred orientation direction of anisotropic molecules of the retardation layers. Comparative Examples 4 and 5 had the same configuration as that of Comparative Example 1 except that the orientation direction of the anisotropic molecules of any of the retardation layers was rotated as shown in Table 3 below, unlike Comparative Example 1.

TABLE 3

| | Compar- | Compar- | COMPAR- |
|---|---|---|---|
| | ative | ative | ATIVE |
| | Example 1 | Example 4 | EXAMPLE 5 |
| Orientation direction of first | 0° | 0° | 10° |
| anisotropic molecules | | | |
| Orientation direction of | 180° | 170° | 170° |
| second anisotropic molecules | | | |
| Orientation direction of | 180° | 190° | 170° |
| third anisotropic | | | |
| molecules | | | |
| Orientation direction of fourth | 0° | 0° | 10° |
| anisotropic molecules | | | |
| Angle formed by the | 0° | 10° | 20° |
| first slow axis and the | | | |
| second slow axis | | | |
| Angle formed by the | 0° | 10° | 20° |
| third slow axis and the | | | |
| fourth slow axis | | | |

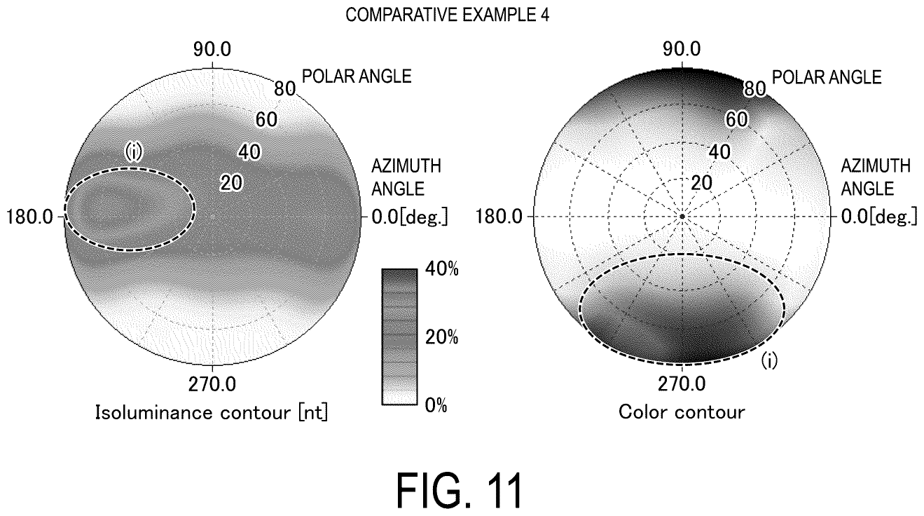

FIG. 11 shows simulation results of a transmittance viewing angle and coloring of an optical element according to Comparative Example 4. From the results of the transmittance viewing angle in FIG. 11, it was found that Comparative Example 4 is not suitable for the polarizing plate louver because, while the light shielding region is vertically narrowed and vertically asymmetric, the maximum luminance region is narrower and deviated from the center of the viewing angle than in Comparative Example 1 as indicated by (i) in the contour diagram showing the transmittance viewing angle. From the results of Comparative Example 4, by rotating the retardation layers included in the upper louver and the lower louver one by one, it was not possible to make the light shielding region vertically asymmetric while maintaining the performance of the polarizing plate louver.

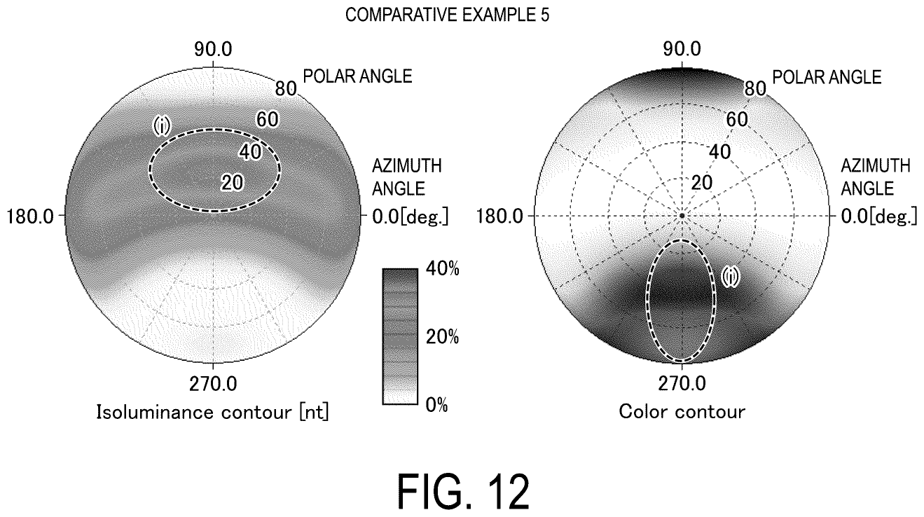

FIG. 12 shows simulation results of a transmittance viewing angle and coloring of an optical element according to Comparative Example 5. From the result of the transmittance viewing angle in FIG. 12, in Comparative Example 5, although the light shielding region was bilaterally symmetric and vertically asymmetric, the maximum luminance region was narrower than that in Comparative Example 1 as indicated by (i) in the contour diagram showing the transmittance viewing angle. Therefore, by rotating all of the four retardation layers of the upper louver and the lower louver, the light shielding region cannot be made vertically asymmetric while maintaining the performance as the polarizing plate louver.

In Comparative Examples 4 and 5, three colors of yellow, purple, and green appeared as the polar angle changes from 20° to 80° at around the azimuth angle of 270° indicated by (i) in the contour diagrams of FIGS. 11 and 12 showing coloring, and the coloring was intense.

### Comparative Examples 6 and 7, Examples 1 and 2

Comparative Examples 6 and 7 and Examples 1 and 2 have the same configuration as that of Comparative Example 1 except that the orientation directions of the anisotropic molecules of the retardation layers included in the lower louver were rotated as shown in Table 4 below.

The third anisotropic molecules were aligned in the direction rotated clockwise with respect to the orientation direction of the second anisotropic molecules, and the fourth anisotropic molecules were aligned in the direction rotated counterclockwise with respect to the orientation direction of the first anisotropic molecules. The rotation angle of the orientation direction of the third anisotropic molecules with respect to the orientation direction of the second anisotropic molecules is −n°, the rotation angle of the orientation direction of the fourth anisotropic molecules with respect to the orientation direction of the first anisotropic molecules is +n°, and the absolute value n of the rotation angle is shown in the following table. The value twice the absolute value n of the rotation angle is the angle formed by the slow axis of the third retardation layer and the slow axis of the fourth retardation layer.

TABLE 4

| | Compar- | Compar- | Compar- | | |
|---|---|---|---|---|---|
| | ative | ative | ative | | |
| | Exam- | Exam- | Exam- | Exam- | Exam- |
| | ple 1 | ple 6 | ple 7 | ple 1 | ple 2 |
| Orientation | 0° | 0° | 0° | 0° | 0° |
| direction of | | | | | |
| first | | | | | |
| anisotropic | | | | | |
| molecules | | | | | |
| Orientation | 180° | 180° | 180° | 180° | 180° |
| direction | | | | | |
| of second | | | | | |
| anisotropic | | | | | |
| molecules | | | | | |
| Orientation | 180° | 160° | 165° | 170° | 175° |
| direction of | | | | | |
| third | | | | | |
| anisotropic | | | | | |
| molecules | | | | | |
| Orientation | 0° | 20° | 15° | 10° | 5° |
| direction of | | | | | |
| fourth | | | | | |
| anisotropic | | | | | |
| molecules | | | | | |
| Rotation angle | n = 0 | n = 20 | n = 15 | n = 10 | n = 5 |
| n (°) | | | | | |
| Angle formed by | 0° | 0° | 0° | 0° | 0° |
| the first slow | | | | | |
| axis and the | | | | | |
| second slow | | | | | |
| axis | | | | | |
| Angle formed by | 0° | 40° | 30° | 20° | 10° |
| the third slow | | | | | |
| axis and the | | | | | |
| fourth slow | | | | | |
| axis | | | | | |

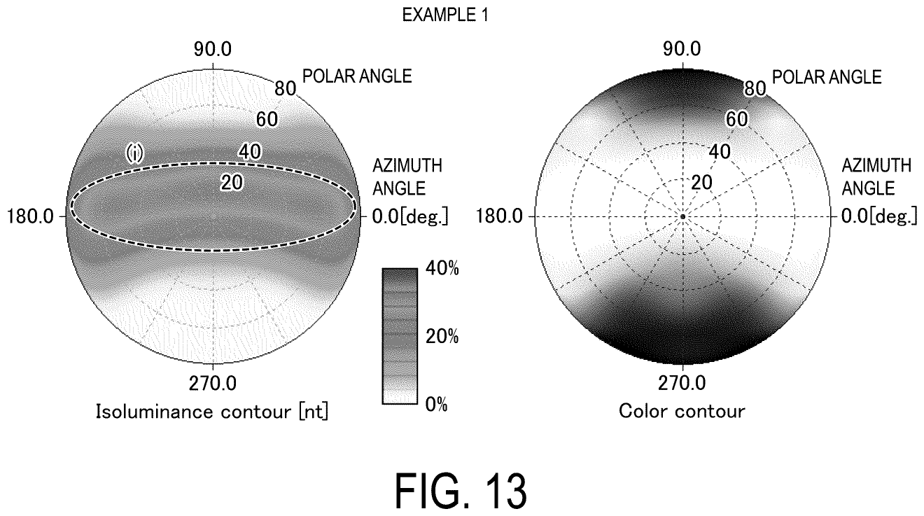

FIG. 13 shows simulation results of a transmittance viewing angle and coloring of an optical element according to Example 1. From the result of the transmittance viewing angle in FIG. 13, in Example 1, the light shielding region was sufficiently narrowed in the vertical direction, and was bilaterally symmetric and vertically asymmetric. Furthermore, as compared with Comparative Examples 2 to 5, the maximum luminance region indicated by (i) in the contour diagram showing the transmittance viewing angle was higher, and the shape was closer to that of Comparative Example 1. From the result of coloring in FIG. 13, coloring at a polar angle of 60° to 80° was substantially eliminated in the vertical azimuthal direction, and color close to black was obtained. At an azimuth angle of 270°, a slight purple color appeared at polar angles of 20° to 40°, but did not appear at an azimuth angle of 90°, and thus, it is believed that there is no problem for use in on-vehicle applications. It was confirmed from the results of Example 1 that, by rotating the orientation direction of anisotropic molecules of two retardation layers included in the lower louver in opposite directions, it was possible to make the light shielding region vertically asymmetric while maintaining the performance as the polarizing plate louver.

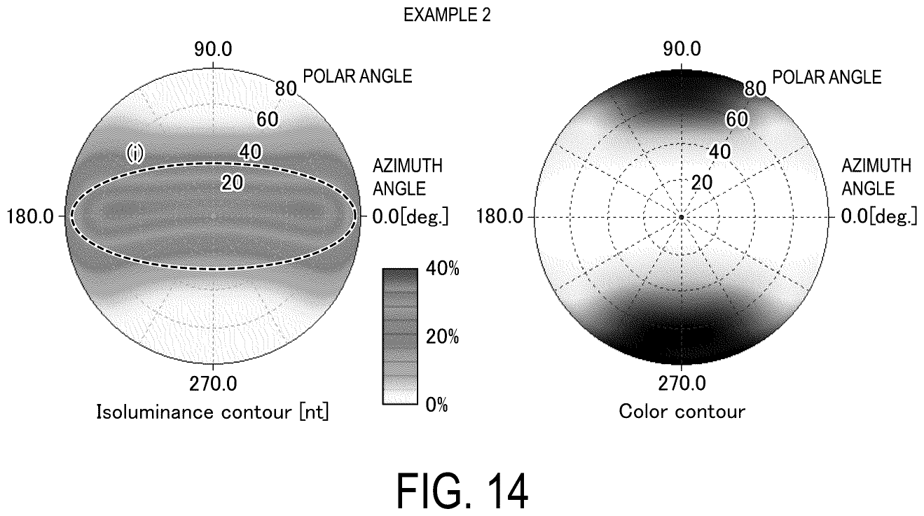

FIG. 14 shows simulation results of a transmittance viewing angle and coloring of an optical element according to Example 2. From the result of the transmittance viewing angle in FIG. 14, in Example 2, the light shielding region was sufficiently narrowed in the vertical direction, and was bilaterally symmetric and vertically asymmetric. The maximum luminance region in Example 2 indicated by (i) in the contour diagram showing the transmittance viewing angle was close to that of Comparative Example 1 than to that of Example 1. In addition, from the result of coloring in FIG. 14, coloring at polar angles of 60° to 80° was darker in the vertical azimuthal direction than in Example 1. In addition, at an azimuth angle of 270°, the purple tone at polar angles of 20° to 40° was significantly reduced as compared with Example 1.

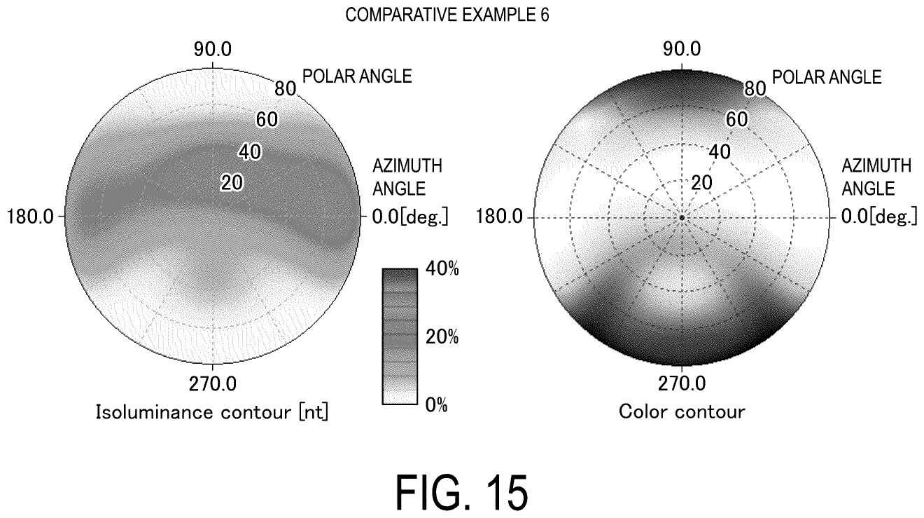

FIG. 15 shows simulation results of a transmittance viewing angle and coloring of an optical element according to Comparative Example 6. From the result of the transmittance viewing angle shown in FIG. 15, in Comparative Example 6, although the light shielding region was bilaterally symmetric and vertically asymmetric, the maximum luminance and the light-shielding performance in the vertical azimuthal direction were significantly reduced as compared with Examples 1 and 2. In addition, from the result of coloring in FIG. 15, intense coloring of purple and yellow appeared at the polar angles of 20° to 80° in the vertical azimuthal direction. From the results of Comparative Example 6, it was found that, even when the orientation directions of the anisotropic molecules of the two retardation layers included in the lower louver were rotated in opposite directions, the performance as the polarizing plate louver deteriorated when the absolute value n of the rotation angle of the orientation directions of the third and fourth anisotropic molecules was 20°, that is, the angle formed by the third slow axis and the fourth slow axis was 40°.

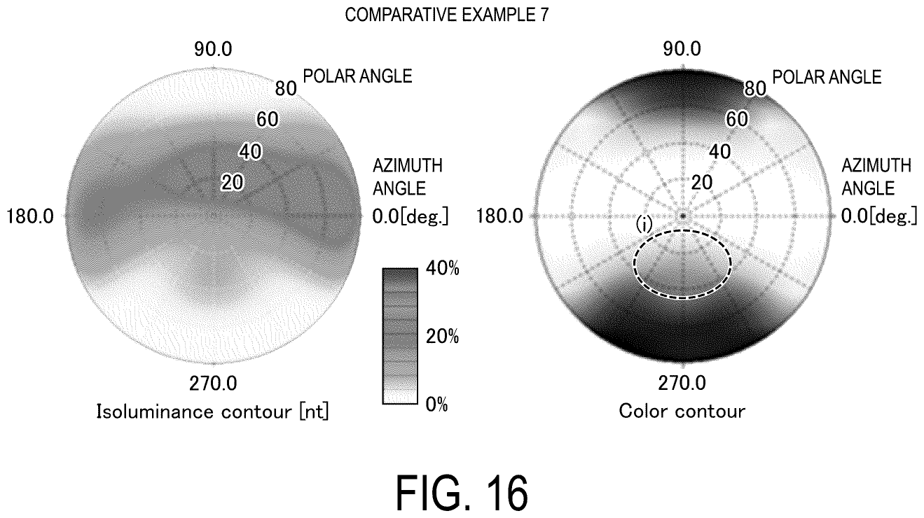

FIG. 16 shows simulation results of a transmittance viewing angle and coloring of an optical element according to Comparative Example 7. From the result of the transmittance viewing angle in FIG. 16, in Comparative Example 6, although the light shielding region was bilaterally symmetric and vertically asymmetric, a decrease in the front luminance was observed. In addition, the maximum luminance was significantly reduced as compared with Examples 1 and 2. As indicated by (i) in the contour diagram showing coloring in FIG. 16, a purple color starts to appear in a shallow polar angle range of 0° to 20°, and this is believed to be not suitable for the polarizing plate louver. From the results of Comparative Example 7, it was found that, even when the orientation directions of the anisotropic molecules of the two retardation layers included in the lower louver were rotated in opposite directions, the performance as the polarizing plate louver deteriorated when the absolute value n of the rotation angle of the orientation directions of the third and fourth anisotropic molecules was 15°, that is, the angle formed by the third slow axis and the fourth slow axis was 30°.

From the results of Examples 1 and 2 and Comparative Examples 6 and 7, it was found that, by setting the rotation angles of the orientation directions of the third and fourth anisotropic molecules to 10° or smaller, that is, by setting the angle formed by the third slow axis and the fourth slow axis to 20° or smaller, the light shielding region can be made vertically asymmetric while maintaining the performance of the polarizing plate louver.

### Study on Transmittance and Chromaticity Shift Δxy

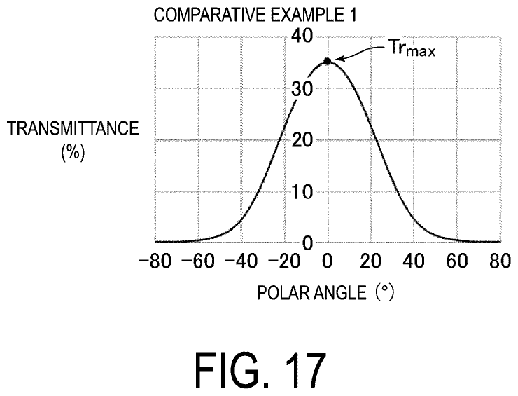

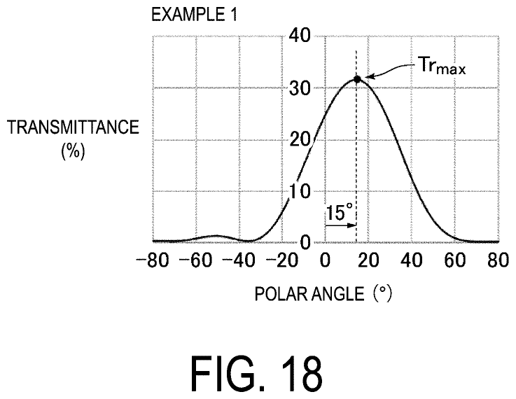

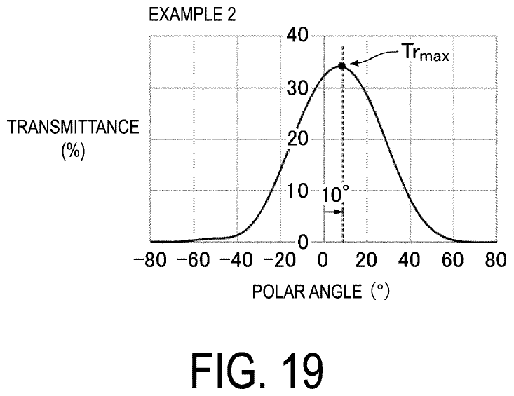

FIG. 17 is a graph showing the transmittance of the optical element according to Comparative Example 1. FIG. 18 is a graph showing the transmittance of the optical element according to Example 1. FIG. 19 is a graph showing the transmittance of the optical element according to Example 2. In each graph, the horizontal axis represents the angle of the polar angle and the vertical axis represents the transmittance (%). The graphs of FIGS. 17 to 19 correspond to the transmittance of the optical elements in which the polar angles are changed from the azimuth angle of 90° to 270° in the contour diagrams showing the transmittance viewing angles of FIGS. 8, 13 and 14, respectively. For the polar angles in FIGS. 17 to 19, the azimuth angle of 90° is represented by a positive value and the azimuth angle of 270° is represented by a negative value, having the normal direction at 0°.

Table 5 below summarizes the maximum transmittance of the graph of Comparative Example 1 shown in FIG. 17, the maximum transmittance of the graph of Example 1 shown in FIG. 18, and the maximum transmittance of the graph of Example 2 shown in FIG. 19. In addition, Table 5 summarizes the values of the chromaticity shift Δxy of Comparative Example 1 and Examples 1 and 2 at an azimuth angle of 90° at a polar angle of 60°. A chromaticity shift Δxy is expressed by the following equation. In the following equation, x₀ and y₀ are an x value and an xy value of an xy chromaticity diagram of the optical element in a normal direction, respectively. The x value and the y value in the xy chromaticity diagram at an azimuth angle of 90° and a polar angle of 60° in each of Comparative Example 1, Example 1, and Example 2 were used as x and y in the following equation for calculation. As the value of Δxy becomes smaller, the color looks closer to an achromatic color (black), which indicates that the color has been improved. Note that when the optical element is used in a vehicle, a user often observes the optical element from above (in an oblique direction at an azimuth angle of 0° to an azimuth angle of 90°), and a lower side of the optical element (in an oblique direction at an azimuth angle of 0° to an azimuth angle of 270°) is substantially invisible to the user. Therefore, Δxy at a polar angle of 60° at an azimuth angle of 90° was studied.

$$Δ xy = \sqrt{{( {x}_{0} - x )}^{2} + {( {y}_{0} - y )}^{2}} \qquad [ Math . 2 ]$$

TABLE 5

| | Comparative | | |
|---|---|---|---|
| | Example 1 | Example 1 | Example 2 |
| Maximum transmittance [%] | 35.1% | 31.6% | 34.0% |
| Transmittance | 1.2% | 2.3% | 1.4% |
| (polar angle of 60°) | | | |
| Δxy | 0.000 | 0.051 | 0.043 |
| (polar angle of 60°) | | | |

As shown in Table 5, the maximum transmittance of Comparative Example 1 was 35.1%, the maximum transmittance of Example 1 was 31.6%, and the maximum transmittance of Example 2 was 34.0%. As shown in FIG. 17, the maximum luminance (peak top) of Comparative Example 1 was at a polar angle of 0° (normal direction), and the graph of the transmittance was substantially symmetrical with respect to the polar angle of 0°, and was symmetrical in the upward direction (azimuth angle of 90°) when the polar angle was a positive value and in the downward direction (azimuth angle of 270°) when the polar angle was a negative value. On the other hand, it was found that, since the peak top of Example 1 was at a polar angle of 15° and the peak top of Example 2 was at a polar angle of 10°, and the peak top was shifted upward from the normal direction, the transmittance was higher in the upper side than in the lower side, and vertical asymmetry was obtained as shown in FIGS. 18 and 19. When Δxy is 0.06 or less, the color cannot be distinguished with the naked eye, and thus the coloring is hard to visually recognize in Examples 1 and 2.

### Study on Range of Rotation Angle

### Comparative Example 8 and Example 3

The rotation angle was changed to 0°, 3°, 5°, 7°, and 10°, and the maximum transmittance, the transmittance at the polar angle of 60° at an azimuth angle of 90°, and Δxy were studied. Comparative Example 8 and Example 3 have the same configuration as that of Comparative Example 1 except that the orientation directions of the anisotropic molecules of the retardation layers included in the lower louver were rotated as shown in Table 6 below.

TABLE 6

| | Compar- | Compar- | | | |
|---|---|---|---|---|---|
| | ative | ative | | | |
| | Exam- | Exam- | Exam- | Exam- | Exam- |
| | ple 1 | ple 8 | ple 2 | ple 3 | ple 1 |
| Orientation | 0° | 0° | 0° | 0° | 0° |
| direction of first | | | | | |
| anisotropic | | | | | |
| molecules | | | | | |
| Orientation | 180° | 180° | 180° | 180° | 180° |
| direction of second | | | | | |
| anisotropic | | | | | |
| molecules | | | | | |
| Orientation | 180° | 177° | 175° | 173° | 170° |
| direction of third | | | | | |
| anisotropic | | | | | |
| molecules | | | | | |
| Orientation | 0° | 3° | 5° | 7° | 10° |
| direction of fourth | | | | | |
| anisotropic | | | | | |
| molecules | | | | | |
| Rotation angle n | n = 0 | n = 3 | n = 5 | n = 7 | n = 10 |
| [°] | | | | | |
| Angle formed by the | 0° | 0° | 0° | 0° | 0° |
| first slow axis and | | | | | |
| the second slow | | | | | |
| axis | | | | | |
| Angle formed by the | 0° | 6° | 10° | 14° | 20° |
| third slow axis and | | | | | |
| the fourth slow | | | | | |
| axis | | | | | |
| Relative ratio of | 100.0% | 99.0% | 96.8% | 95.0% | 90.0% |
| maximum | | | | | |
| transmittance [%] | | | | | |
| Transmittance | 1.2% | 1.3% | 1.6% | 2.0% | 3.0% |
| (polar angle of | | | | | |
| 60°) | | | | | |
| Δxy (polar angle of | 0.000 | 0.037 | 0.043 | 0.05 | 0.051 |
| 60°) | | | | | |

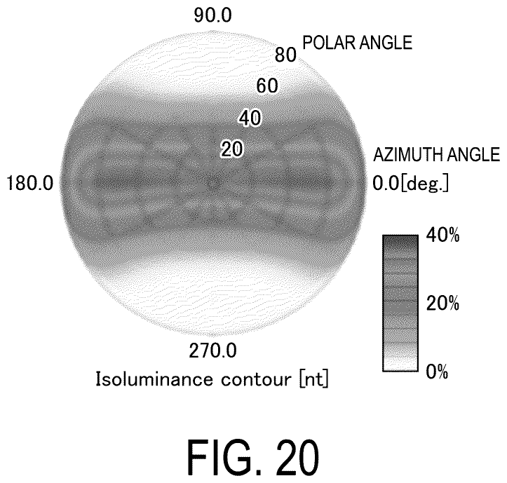

FIG. 20 shows simulation results of a transmittance viewing angle of an optical element according to Comparative Example 8. As shown in FIG. 20, in Comparative Example 8 in which the rotation angle n was 3°, the light shielding region was vertically symmetrical.

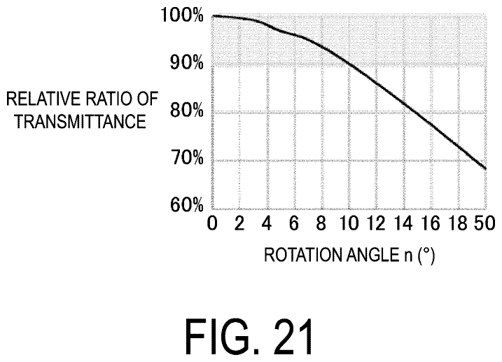

FIG. 21 is a graph showing the relationship between the rotation angle of anisotropic molecules in the orientation direction and the relative ratio of the maximum transmittance. A relative ratio of transmittance represents a relative ratio of the maximum transmittance of each of Examples and Comparative Examples when the maximum transmittance of Comparative Example 1 is set to 100%. It can be said that, when the relative ratio of the maximum transmittance is ±10%, the transmittance is sufficiently high. In FIG. 21, the preferable range is indicated by hatching. From FIG. 20, it was found that a high transmittance can be maintained in the horizontal azimuthal direction in the range of the rotation angle n=0° to 10°. Furthermore, it was found that the maximum transmittance tends to decrease as the rotation angle increases.

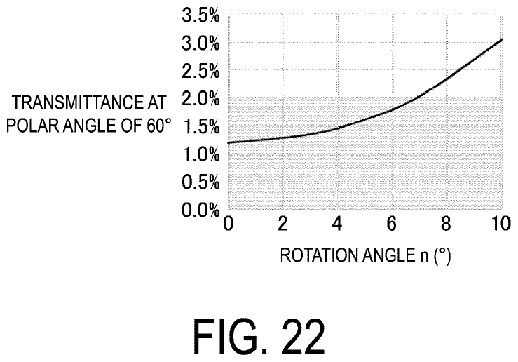

According to the study of the present inventors, when the optical element is used for an in-vehicle display or the like, the display is installed at a position slightly lower than the line of sight when viewed from the driver side, the driver actually looks at the upper half portion of the display in the range of polar angles 20° to 60°, and thus if an optical element having general specifications is used, display light with a polar angle of more than 60° may be reflected on the windshield. Therefore, the transmittance at the polar angle of 60° at an azimuth angle of 90° was studied. FIG. 22 is a graph showing the relationship between the rotation angle of anisotropic molecules in the orientation direction and the transmittance at the polar angle of 60° at an azimuth angle of 90°. In FIG. 22, the preferable range is indicated by hatching. From FIG. 22, it was found that as the absolute value n of the rotation angle increases, the light shielding effect in an oblique direction tends to decrease. When the transmittance at the polar angle of 60° at an azimuth angle of 90° exceeds 2.0%, reflection on the windshield is likely to occur. In consideration of reflection on the windshield, the transmittance at the polar angle of 60° at an azimuth angle of 90° is preferably 2.0% or less, and the rotation angle n is preferably 7° or smaller. In addition, the angle formed by the slow axis of the third retardation layer and the slow axis of the fourth retardation layer is preferably 14° or smaller.

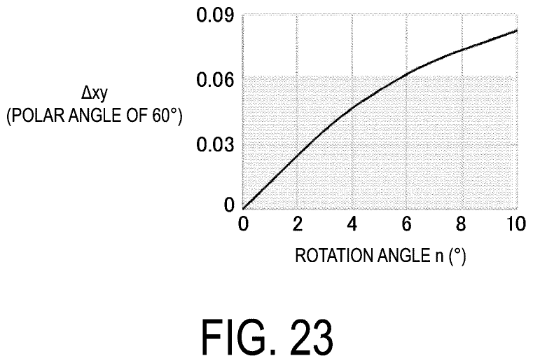

FIG. 23 is a graph showing the relationship between the rotation angle of anisotropic molecules in the orientation direction and Δxy. From FIG. 23, it was found that as the absolute value n of the rotation angle increases, coloring in an oblique direction tends to occur. In FIG. 23, the preferable range is indicated by hatching. When Δxy at the polar angle of 60° at an azimuth angle of 90° exceeds 0.06, coloring is likely to be visually recognized. Therefore, from the viewpoint of curbing coloring, Δxy at the polar angle of 60° at an azimuth angle of 90° is particularly preferably equal to or less than 0.06 and the rotation angle n is preferably equal to or smaller than 6°. In consideration of both the light shielding rate and the coloring described above, it was found that excellent louver and characteristics can be obtained by setting the rotation angle n to 6° or smaller. Since the rotation angle n is preferably 6° or smaller, the angle formed by the slow axis of the third retardation layer and the slow axis of the fourth retardation layer is preferably 12° or smaller. In Example 3 and Comparative Example 8, Δxy was 0.06 or less, which was a value at which coloring was hardly visible with the naked eye.

### Study Examples 1 to 3

The relationship between the retardation of the negative C plate and the transmittance in an oblique direction was studied below. Optical elements according to Study Examples 1 to 3 were manufactured in the same manner as in Comparative Example 1 except that the retardations of the negative C plates were changed to 100 nm, 200 nm, and 400 nm, respectively. Table 7 below summarizes transmittances at the polar angle of 60° of the azimuth angle of 90°.

TABLE 7

| | | | Compar- | |
|---|---|---|---|---|
| | Study | Study | ative | Study |
| | Exam- | Exam- | Exam- | Exam- |
| | ple 1 | ple 2 | ple 1 | ple 3 |
| Retardation of negative C plate | 100 nm | 200 nm | 300 nm | 400 nm |
| Transmittance at polar | 6.3% | 3.0% | 1.0% | 1.0% |
| angle of 60° (azimuth angle | | | | |
| of 90°) | | | | |

As shown in Table 7, it was confirmed that, when the retardation of the negative C plate was equal to or greater than 300 nm, the transmittance in an oblique direction could be reduced to approximately 1%.

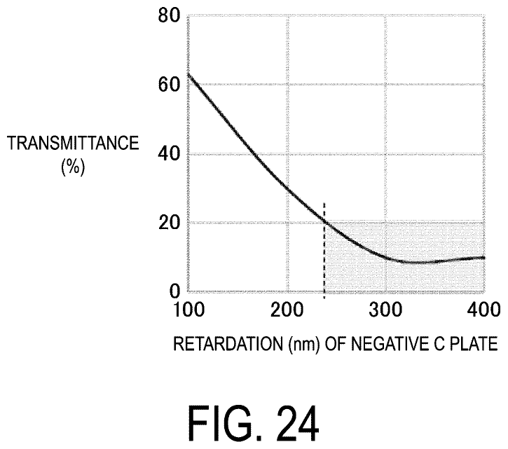

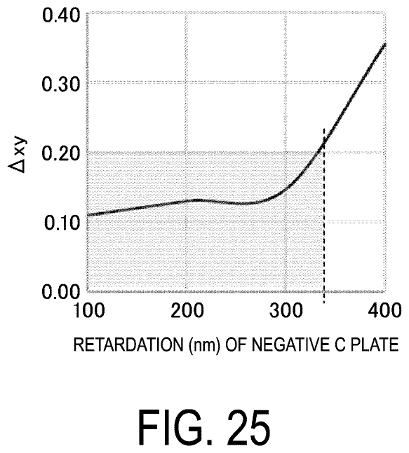

FIG. 24 is a graph showing the relationship between the retardation of a negative C plate in a thickness direction and a transmittance. FIG. 25 is a graph showing the relationship between the retardation of the negative C plate in the thickness direction and Δxy. It is preferable that a polarizing plate louver have a transmittance of 2.0% or less at the polar angle of 60° at an azimuth angle of 90° and a chromaticity shift Δxy of 0.2 or less at the polar angle of 60° at an azimuth angle of 90°. As shown in FIG. 24, when the retardation of the negative C plate in the thickness direction was approximately 250 nm or more, a transmittance at the polar angle of 60° at an azimuth angle of 90° was 2% or less. As shown in FIG. 25, when the retardation of the negative C plate in the thickness direction was approximately 320 nm or less, the chromaticity shift Δxy was 0.2 or less. From these results, the retardation of the negative C plate in the thickness direction is preferably 250 nm or more and 320 nm or less.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An optical element comprising:
a first polarizer;
a first retardation layer including first anisotropic molecules;
a negative C plate;
a second retardation layer including second anisotropic molecules;
a second polarizer;
a third retardation layer including third anisotropic molecules;
a fourth retardation layer including fourth anisotropic molecules; and
a third polarizer in this order,
wherein the first anisotropic molecules vary in a manner that tilt angles of the first anisotropic molecules increase from the first polarizer side of the first retardation layer toward the negative C plate side of the first retardation layer,
the second anisotropic molecules vary in a manner that tilt angles of the second anisotropic molecules increase from the second polarizer side of the second retardation layer toward the negative C plate side of the second retardation layer,
the third anisotropic molecules vary in a manner that tilt angles of the third anisotropic molecules decrease from the second polarizer side of the third retardation layer toward the fourth retardation layer side of the third retardation layer,
the fourth anisotropic molecules vary in a manner that tilt angles of the fourth anisotropic molecules decrease from the third polarizer side of the fourth retardation layer toward the third retardation layer side of the fourth retardation layer,
an absorption axis or a reflection axis of the first polarizer, an absorption axis or a reflection axis of the second polarizer, and an absorption axis or a reflection axis of the third polarizer are parallel to each other in a plan view,
the absorption axis or the reflection axis of the first polarizer and a slow axis of the first retardation layer are orthogonal to each other in a plan view,
the slow axis of the first retardation layer and a slow axis of the second retardation layer are parallel to each other in a plan view,
a slow axis of the third retardation layer and a slow axis of the fourth retardation layer intersect each other in a plan view, and
an angle formed by the slow axis of the third retardation layer and the slow axis of the fourth retardation layer is 10° or greater and 20° or smaller.

2. The optical element according to claim 1,
wherein an angle formed by the slow axis of the second retardation layer and the slow axis of the third retardation layer is 5° or greater and 10° or smaller, and
an angle formed by the slow axis of the first retardation layer and the slow axis of the fourth retardation layer is 5° or greater and 10° or smaller.

3. The optical element according to claim 1,
wherein, when a surface of the first retardation layer on the first polarizer side is assumed to be a first surface, a surface of the second retardation layer on the second polarizer side is assumed to be a second surface, a surface of the third retardation layer on the second polarizer side is assumed to be a third surface, and a surface of the fourth retardation layer on the third polarizer side is assumed to be a fourth surface, and
an azimuthal direction in which directions along long axes of the first anisotropic molecules from a side closer to the second surface of the first retardation layer toward a side closer to the first surface of the first retardation layer are projected onto the first surface is assumed to be an orientation direction of the first anisotropic molecules,
an azimuthal direction in which directions along long axes of the second anisotropic molecules from a side closer to the second surface of the second retardation layer toward a side closer to the first surface of the second retardation layer are projected onto the second surface is assumed to be an orientation direction of the second anisotropic molecules,
an azimuthal direction in which directions along long axes of the third anisotropic molecules from a side closer to the fourth surface of the third retardation layer toward a side closer to the third surface of the third retardation layer are projected onto the third surface is assumed to be an orientation direction of the third anisotropic molecules, and
an azimuthal direction in which directions along long axes of the fourth anisotropic molecules from a side closer to the fourth surface of the fourth retardation layer toward a side closer to the third surface of the fourth retardation layer are projected onto the fourth surface is assumed to be an orientation direction of the fourth anisotropic molecules,
the orientation direction of the first anisotropic molecules and the orientation direction of the second anisotropic molecules are different from each other by 180°±3° in a plan view.

4. The optical element according to claim 3,
wherein, when a horizontal rightward direction of the optical element viewed from a side of the first polarizer is an azimuth angle of 0°, a counterclockwise direction from the azimuth angle of 0° is a positive angle, and a clockwise direction from the azimuth angle of 0° is a negative angle,
the orientation direction of the first anisotropic molecules is 0°±3° and the orientation direction of the second anisotropic molecules is 180°±3°, or
the orientation direction of the first anisotropic molecules is 180°±3° and the orientation direction of the second anisotropic molecules is 0°±3°.

5. The optical element according to claim 3,
wherein, in a plan view, the orientation direction of the third anisotropic molecules is an azimuthal direction obtained by rotating the orientation direction of the second anisotropic molecules in one of a clockwise direction and a counterclockwise direction by a predetermined angle, and in a plan view, the orientation direction of the fourth anisotropic molecules is an azimuthal direction obtained by rotating the orientation direction of the first anisotropic molecules in the other of the clockwise direction and the counterclockwise direction by the predetermined angle.

6. The optical element according to claim 5,
wherein the predetermined angle is 5° or greater and 10° or smaller.

7. The optical element according to claim 1,
wherein a retardation of the negative C plate in a thickness direction is 250 nm or more and 320 nm or less.

8. The optical element according to claim 1,
wherein a rate of variation in the tilt angles of the first anisotropic molecules from the first polarizer side to the negative C plate side in a thickness direction of the first retardation layer is equal to a rate of variation in the tilt angles of the second anisotropic molecules from the second polarizer side to the negative C plate side in a thickness direction of the second retardation layer.

9. The optical element according to claim 1,
wherein a rate of variation in the tilt angles of the third anisotropic molecules from the fourth retardation layer side to the second polarizer side in a thickness direction of the third retardation layer is equal to a rate of variation in the tilt angles of the fourth anisotropic molecules from the third retardation layer side to the third polarizer side in a thickness direction of the fourth retardation layer.

10. The optical element according to claim 1,
wherein the first polarizer is an absorptive polarizer, a reflective polarizer, or a layered body of an absorptive polarizer and a reflective polarizer,
the second polarizer is an absorptive polarizer or a reflective polarizer, and
the third polarizer is an absorptive polarizer, a reflective polarizer, or a layered body of an absorptive polarizer and a reflective polarizer.

11. A display device comprising:
a liquid crystal panel;
the optical element according to claim 1; and
a backlight in this order,
wherein the optical element is disposed in a manner that the first polarizer is on a side of the liquid crystal panel.

12. The display device according to claim 11,
wherein the backlight includes an irradiation unit and a prism sheet disposed on an observation surface side of the irradiation unit,
the prism sheet is provided with a plurality of rows of linear protruding portions extending parallel to each other on a surface on the observation surface side, and
the absorption axis or the reflection axis of the first polarizer is parallel or orthogonal to ridge lines of the linear protruding portions in a plan view.
